(19) United States
(12) Patent Application Publication
(10) Pub. No.: US 2004/0004741 A1
(43) Pub. Date: Jan. 8, 2004

(54) Information processing system and information processing method

(75) Inventors: Kazushi Ozawa, Tokyo (JP); Kazuyuki Tsukamoto, Kanagawa (JP); Shin Takeuchi, Kanagawa (JP); Katsumi Sakamaki, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Minato-ku (JP)

(21) Appl. No.: 10/383,546

(22) Filed: Mar. 10, 2003

(30) Foreign Application Priority Data
Apr. 22, 2002 (JP) 2002-119681
May 27, 2002 (JP) 2002-152766

(51) Int. Cl. H04N 1/387

(52) U.S. Cl. 358/453

(57) ABSTRACT

In an information processing system, common image display management means of a management apparatus transmits image data in a web site to information processing apparatuses in response to requests received from the information processing apparatuses, and causes image display sections to display a common image. Relation giving means first executes user recognition, and relates an input command to an input section concerning a first position in the common image displayed on the image display section and an input command to an input section concerning a second position in the common image displayed on the image display section to each other. Correlation stimulus presentation means causes stimulus presentation sections each to present a touch stimulus responsive to the correlation between the first position and the second position in the common images displayed on the image display sections.

The present disclosure relates to the subject matter contained in Japanese Patent Application No. 2002-119681 filed Apr. 22, 2002 and Japanese Patent Application No. 2002-152766 filed May 27, 2002, which are incorporated herein by reference in their entirety.

### BACKGROUND OF THE INVENTION

1. Field of the Invention

This invention relates to an information processing system having a first information processing apparatus and a second information processing apparatus connected through a network and an information processing method using the information processing system.

Also, this invention relates to an information processing system and an information processing method for presenting a haptic sense, thereby conducting communications.

2. Description of the Related Art

Generally, an information processing system operates based on operation of one operator. For example, assuming that access is made from a computer connected to the Internet to a web site, one operator A operates an input section (keyboard, mouse, etc.,) of the computer, thereby accessing the web site desired by the operator A, and information in the web site is displayed as image on an image display section of the computer. Generally, the person who operates the input section of the computer is the operator A only and the person who sees the image displayed on the image display section of the computer is also the operator A only.

The person in the proximity of the computer can see the image displayed on the image display section, but generally does not operate the input section. The person at a distant from the computer can neither see the image displayed on the image display section and nor operate the input section.

By the way, in the actual world, often, as two (or three or more) persons have information in common, “enjoyment” and “easiness to understand” grow. For example, shopping with two together (a pair of lovers, husband and wife, parent and child, etc.,) is more enjoyable than shopping with one solely. For example, learning with two (classmates, teacher and pupil, etc.,) while communicating with each other is more enjoyable and easier to understand than learning with one solely. However, shopping and learning on the Internet assume that one operator uses the input section and the image display section of the computer, and two persons cannot be involved in shopping or learning while holding information in common.

In recent years, human beings at a distance from each other have frequently conducted communications of image, voice, etc., with each other with widespread use of two-way communication means of the Internet, etc. At present, communications only using visual sensation and auditory sense are conducted, but it can be expected that communications using a haptic sense will be conducted in the future with development and widespread use of haptic sense presentation machines.

Such a haptic sense presentation machine used for haptic sense communications is disclosed in Document 1: Scott Brave, Hiroshi Ishii, Andrew Dahley, “Tangible Interfaces for Remote Collaboration and Communication” (Published in the Proceedings of CSCW '98, p1-10, Nov. 14-18 (1998)), for example. A roller-like device operated with a palm is used and is controlled by a symmetric bilateral servo system and two persons conduct haptic sense communications using the haptic sense of the palm of each person. The symmetric bilateral servo system is a control system for measuring a position error between the two objects to be controlled and giving a force in the direction correcting the position error to both the objects.

For a plurality of operators to conduct haptic sense communications using the haptic sense presentation machines as described above, each of the haptic sense presentation machines needs to receive position data from all other haptic sense presentation machines. Thus, the communication data amount increases rapidly with an increase in the number of the connected haptic sense presentation machines, and control of the haptic sense in each haptic sense presentation machine may become unstable because of lowering of the communication speed, etc.

### SUMMARY OF THE INVENTION

It is therefore an object of the invention to provide an information processing system and an information processing method for enabling a plurality of persons to have information in common if they are at a distance from each other.

It is therefore another object of the invention to provide an information processing system and an information processing method for making it possible to stably control a haptic sense in each haptic sense presentation machine by suppressing the amount of data transferred between the haptic sense presentation machines.

According to the invention, there is provided an information processing system comprising (1) a first information processing apparatus having a first input section for accepting an input command given by a first operator, a first image display section for displaying an image for the first operator, and a first stimulus presentation section for presenting a touch stimulus to the first operator; (2) a second information processing apparatus which is connected to the first information processing apparatus through a network and has a second input section for accepting an input command given by a second operator, a second image display section for displaying an image for the second operator, and a second stimulus presentation section for presenting a touch stimulus to the second operator; (3) common image display management means for causing the first image display section and the second image display section each to display a common image; (4) relation giving means for relating an input command to the first input section concerning a first position in the common image displayed on the first image display section and an input command to the second input section concerning a second position in the common image displayed on the second image display section to each other; and (5) correlation stimulus presentation means for causing the first stimulus presentation section and the second stimulus presentation section each to present a touch stimulus responsive to the correlation between the first position and the second position in the common images when the relation giving means relates the input command to the first input section and the input command to the second input section to each other.

According to the invention, there is provided an information processing method using an information processing system comprising (1) a first information processing apparatus having a first input section for accepting an input command given by a first operator, a first image display section for displaying an image for the first operator, and a first stimulus presentation section for presenting a touch stimulus to the first operator; and (2) a second information processing apparatus which is connected to the first information processing apparatus through a network and has a second input section for accepting an input command given by a second operator, a second image display section for displaying an image for the second operator, and a second stimulus presentation section for presenting a touch stimulus to the second operator, the information processing method comprising the steps of (a) causing the first image display section and the second image display section each to display a common image; (b) relating an input command to the first input section concerning a first position in the common image displayed on the first image display section and an input command to the second input section concerning a second position in the common image displayed on the second image display section to each other; and (c) causing the first stimulus presentation section and the second stimulus presentation section each to present a touch stimulus responsive to the correlation between the first position and the second position in the common images when the input command to the first input section and the input command to the second input section are related to each other.

According to the invention, the first operator can give an input command to the first input section of the first information processing apparatus, can see the image displayed on the first image display section of the first information processing apparatus, and can receive the touch stimulus presented in the first stimulus presentation section of the first information processing apparatus. On the other hand, the second operator can give an input command to the second input section of the second information processing apparatus, can see the image displayed on the second image display section of the second information processing apparatus, and can receive the touch stimulus presented in the second stimulus presentation section of the second information processing apparatus. The first information processing apparatus and the second information processing apparatus are connected through the network. The first operator and the second operator can see the common images displayed on the first image display section and the second image display section by the common image display management means. The relation giving means relates the input command to the first input section given by the first operator concerning the first position in the common image and the input command to the second input section given by the second operator concerning the second position in the common image to each other. The correlation stimulus presentation means causes the first stimulus presentation section and the second stimulus presentation section each to present the touch stimulus responsive to the correlation between the first position and the second position in the common images, so that the first operator and the second operator can each receive the touch stimulus responsive to the correlation. Thus, the first operator and the second operator can receive the touch stimulus responsive to the input command position of the associated party relative to the input command position on the common image and can have information in common if they are at a distance from each other.

In the information processing system according to the invention, preferably, when the relation giving means relates the input command to the first input section and the input command to the second input section to each other, the common image display management means causes the first image display section and the second image display section each to display image information responsive to the correlation on the common image displayed on the first image display section and the second image display section. In the information processing method according to the invention, preferably, when the input command to the first input section and the input command to the second input section are related to each other, the first image display section and the second image display section are caused each to display image information responsive to the correlation on the common image displayed on the first image display section and the second image display section. In this case, the common image display management means causes the first image display section and the second image display section each to display image information responsive to the correlation between the first position and the second position in the common image, so that the first operator and the second operator can see the image information responsive to the correlation.

Preferably, the information processing system according to the invention further comprises charging management means for charging either of the first and second operators based on previously registered information concerning charging of the operators. Preferably, the information processing method according to the invention further comprises the step of charging either of the first and second operators based on previously registered information concerning charging of the operators.

Preferably, the information processing system according to the invention further comprises master and slave relationship giving means for setting relationship of master and slave between operation of the first operator and operation of the second operator. Preferably, the information processing method according to the invention further comprises the step of setting relationship of master and slave between operation of the first operator and operation of the second operator.

According to the invention, there is provided an information processing system comprising N haptic sense presentation systems (where N is an integer of two or more) and a server being connected to the N haptic sense presentation systems through a network, wherein each of the N haptic sense presentation systems comprises a moving part that can be displaced; a displacement detection section for generating displacement information based on displacement input to the moving part; control means for displacing the moving part for presenting a haptic sense according to a displacement command value; and a first communication section for transmitting the displacement information generated by the displacement detection section to the server and receiving the displacement command value from the server and sending the displacement command value to the control means, and wherein the server comprises a second communication section for receiving the displacement information from each of the N haptic sense presentation systems and transmitting the displacement command value to each of the N haptic sense presentation systems; and displacement command value generation means for generating the displacement command value for instructing the control means of each of the N haptic sense presentation systems to displace the moving part for presenting a haptic sense based on the displacement information generated by the displacement detection section of each of the N haptic sense presentation systems and sent from the first communication section through the network to the second communication section.

According to the invention, there is provided an information processing method using N haptic sense presentation systems (where N is an integer of two or more) each comprising a moving part that can be displaced and a server being connected to the N haptic sense presentation systems through a network, the information processing method comprising a displacement detection step of generating displacement information based on displacement input to the moving part of each of the N haptic sense presentation systems; a first communication step of transmitting the displacement information generated in the displacement detection step from each of the N haptic sense presentation systems to the server; a displacement command value generation step of generating in the server a displacement command value for instructing the moving part of each of the N haptic sense presentation systems to be displaced for presenting a haptic sense based on the displacement information generated in the displacement detection step and sent from the first communication step; a second communication step of transmitting the displacement command value generated in the displacement command value generation step from the server to each of the N haptic sense presentation systems; and a control step of displacing the moving part of each of the N haptic sense presentation systems for presenting a haptic sense according to the displacement command value sent from the second communication step to each of the N haptic sense presentation systems.

In the information processing system (information processing method), the server connected to the network collectively generates the displacement command values for instructing the control means (control step) to displace the moving parts of the N haptic sense presentation systems, and sends the displacement command values to the haptic sense presentation systems. Thus, the amount of data communicated on the network can be suppressed, and the haptic sense presented by the moving part of each haptic sense presentation system can be controlled stably.

In the information processing system, the server may further comprise a moving part that can be displaced; a displacement detection section for generating displacement information based on displacement input to the moving part; and control means for displacing the moving part for presenting a haptic sense according to a displacement command value; and the displacement command value generation means may generate the displacement command value for instructing the control means of each of the server and the N haptic sense presentation systems to displace the moving part for presenting a haptic sense based on the displacement information generated by the displacement detection section of the server and the displacement information generated by the displacement detection section of each of the N haptic sense presentation systems and sent from the first communication section through the network to the second communication section.

In the information processing method, the server may comprise a moving part that can be displaced, the displacement detection step may be to further generate displacement information based on displacement input to the moving part of the server, the displacement command value generation step may be to generate in the server the displacement command value for instructing the moving part of each of the server and the N haptic sense presentation systems to be displaced for presenting a haptic sense based on the displacement information generated in the displacement detection step based on displacement input to the moving part of each of the server and the N haptic sense presentation systems, and the control step may be to displace the moving part of each of the server and the N haptic sense presentation systems for presenting a haptic sense according to the displacement command value generated in the displacement command value generation step.

In the information processing system (information processing method), in addition to each haptic sense presentation system, the server also includes the moving part, the displacement detection section (displacement detection step), and the control means (control step), so that also in the server, the operator can take part in haptic sense communication.

### BRIEF DESCRIPTION OF THE DRAWINGS

FIG. 1 is a block diagram of an information processing system 1 according to an embodiment of the invention;

FIG. 2 is a sectional view of a device 100 including a stimulus presentation section 14;

FIG. 3 is a block diagram of the device 100 including the stimulus presentation section 14;

FIGS. 4A and 4B are more detailed configuration drawings of the fixed member 111 and the moving member 112 of the device 100 including the stimulus presentation section 14;

FIG. 5 is a plan view to describe a touch stimulus presentation mechanism in the device 100 including the stimulus presentation section 14;

FIG. 6 is a sectional view to describe a slide mechanism of the fixed member 111 and the moving member 112 in the device 100 including the stimulus presentation section 14;

FIG. 7 is a sectional view to describe a pressure-sensitive part 120 in the device 100 including the stimulus presentation section 14;

FIG. 8 is a sectional view to describe a position detection sensor 114 in the device 100 including the stimulus presentation section 14;

FIG. 9 is a drawing to show an example of common images displayed on image display sections 13 and 23;

FIG. 10 is a drawing to show an example of the common image displayed on the image display section 13;

FIG. 11 is a drawing to show another example of the common image displayed on the image display section 13;

FIG. 12 is a general view to show another embodiment of an information processing system according to the invention;

FIG. 13 is a block diagram to show the internal configuration of the information processing system;

FIG. 14 is a sectional view to show the configuration of the operation section;

FIG. 15 is a block diagram to show the configuration of an input/output section;

FIGS. 16A and 16B are more detailed configuration drawings of a fixed member and a moving part of the input/output section;

FIG. 17 is a plan view to describe a haptic sense presentation mechanism of the input/output section;

FIG. 18 is a sectional view to describe a slide mechanism of the fixed member and the moving part in the input/output section;

FIG. 19 is a sectional view to describe a pressure-sensitive part 170 of the operation section;

FIG. 20 is a sectional view to describe a displacement detection sensor contained in the input/output section;

FIG. 21 is a flowchart to show the operation of the information processing system;

FIG. 22 is a block diagram to show the internal configuration of an information processing system according to still another embodiment of the invention;

FIG. 23 is a flowchart to show the operation of the information processing system;

FIG. 24 is a block diagram to show an example of an information processing system in a related art; and

FIG. 25 is a block diagram to show an example of another information processing system in a related art.

### DETAILED DESCRIPTION OF THE PREFERRED EMBODIMENTS

Referring now to the accompanying drawings, there is shown a preferred embodiment of the invention. In the drawings, the same elements are denoted by the same reference numerals and duplicate description is omitted.

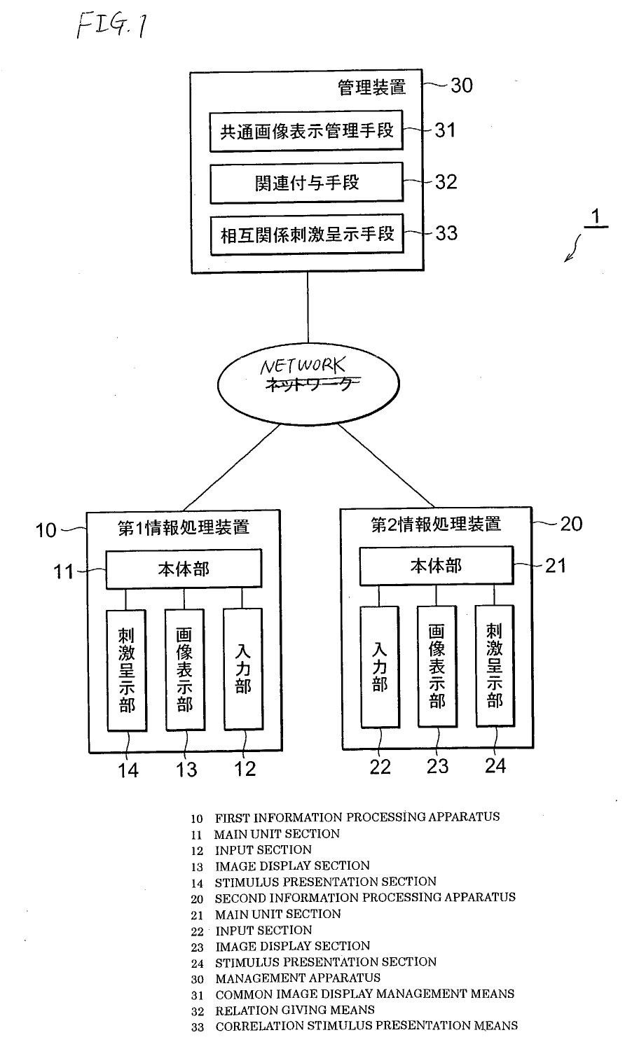

FIG. 1 is a block diagram of an information processing system 1 according to an embodiment of the invention. The information processing system 1 shown in the figure has a first information processing apparatus 10, a second information processing apparatus 20, and a management apparatus 30 connected through a network. The management apparatus 30 is, for example, a server, and the information processing apparatus 10 and the second information processing apparatus 20 can operate under the control of the management apparatus 30 and are, for example, personal computers. The network is, for example, the Internet.

The information processing apparatus 10 has a main unit section 11, an input section 12, an image display section 13, and a stimulus presentation section 14. The input section 12 accepts an input command from an operator A operating the information processing apparatus 10 and is, for example, a keyboard, a mouse, a joystick, a trackball, or the like. The image display section 13 displays an image for the operator A. The stimulus presentation section 14 presents a touch stimulus to the operator A. The main unit section 11 inputs a signal of the input command accepted by the input section 12, controls image display on the image display section 13 based on the signal, and controls touch stimulus presentation of the stimulus presentation section 14.

The main unit section 11 has a CPU for controlling the whole operation of the information processing apparatus 10 and performing computation, storage for storing application software, driver software, and data, and the like. The main unit section 11 controls an interface section connected to the network for transmitting and receiving data to and from the management apparatus 30 through the network. In the data transmission and reception to and from the management apparatus 30, the main unit section 11 transmits the signal of the input command accepted by the input section 12 to the management apparatus 30, receives data sent from the management apparatus 30, causes the image display section 13 to display an image based on the data, and causes the stimulus presentation section 14 to present a touch stimulus based on the data.

The information processing apparatus 20 has a main unit section 21, an input section 22, an image display section 23, and a stimulus presentation section 24. The input section 22 accepts an input command from an operator B operating the information processing apparatus 20 and is, for example, a keyboard, a mouse, a joystick, a trackball, or the like. The image display section 23 displays an image for the operator B. The stimulus presentation section 24 presents a touch stimulus to the operator B. The main unit section 21 inputs a signal of the input command accepted by the input section 22, controls image display on the image display section 13 based on the signal, and controls touch stimulus presentation of the stimulus presentation section 24.

The main unit section 21 has a CPU for controlling the whole operation of the information processing apparatus 20 and performing computation, storage for storing application software, driver software, and data, and the like. The main unit section 21 controls an interface section connected to the network for transmitting and receiving data to and from the management apparatus 30 through the network. In the data transmission and reception to and from the management apparatus 30, the main unit section 21 transmits the signal of the input command accepted by the input section 22 to the management apparatus 30, receives data sent from the management apparatus 30, causes the image display section 23 to display an image based on the data, and causes the stimulus presentation section 24 to present a touch stimulus based on the data.

The application software stored in the storage of the main unit section 11, 21 includes, for example, browser software for causing the image display section 13, 23 to display information in the web site accessed through the Internet, electronic mail transmission-reception software for transmitting and receiving electronic mail to and from any other information processing apparatus, and the like. The driver software stored in the storage of the main unit section 11, 21 includes, for example, driver software for controlling the operation of the input section 12, 22, driver software for controlling the operation of the stimulus presentation section 14, 24, and the like.

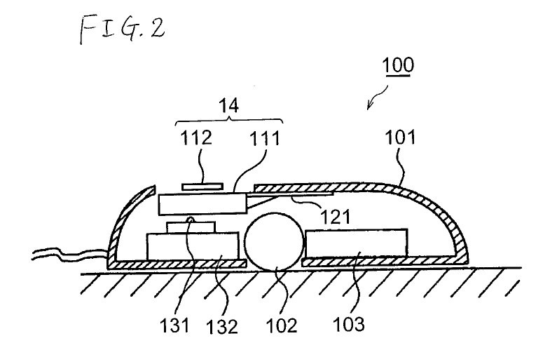

Next, the configuration of a device 100 including the stimulus presentation section 14 of the information processing apparatus 10 will be discussed with reference to FIGS. 2 to 8. The description to follow is also applied to the stimulus presentation section 24 of the information processing apparatus 20. The device 100 shown in FIGS. 2 to 8 has the stimulus presentation section 14 as well as a pointing function of a traditional mouse (partial function of the input section 12).

FIG. 2 is a sectional view of the device 100 including the stimulus presentation section 14. The device 100 has a shape roughly similar to that of a traditional mouse and includes a main unit section 101, a ball 102, and first displacement detection means 103, which are elements for providing the pointing function of the traditional mouse. The ball 102 is on the bottom of the main unit section 101 and can rotate. As the main unit section 101 moves on a reference surface (for example, a desktop surface or a mouse pad), the ball 102 rotates. The first displacement detection means 103 detects the rotation direction and the rotation amount of the ball 102 by an encoder, thereby detecting two-dimensional displacement (move direction and move distance) of the main unit section 101 relative to the reference surface.

The device 100 also includes a fixed member 111, a moving member 112, and a support member 121, which are elements making up the stimulus presentation section 14. The fixed member 111 is fixed to the top of the main unit section 101 via the support member 121 that can elastically bend. The moving member 112 can move relative to the fixed member 111.

The device 100 further includes a switch 131 and a signal processing circuit 132. As the moving member 112 is pressed with a finger, etc., of the operator of the device 100, the fixed member 111 presses the switch 131. That is, the switch 131 detects the moving member 112 being pressed, and the signal processing circuit 132 outputs a signal indicating that the moving member 112 is pressed.

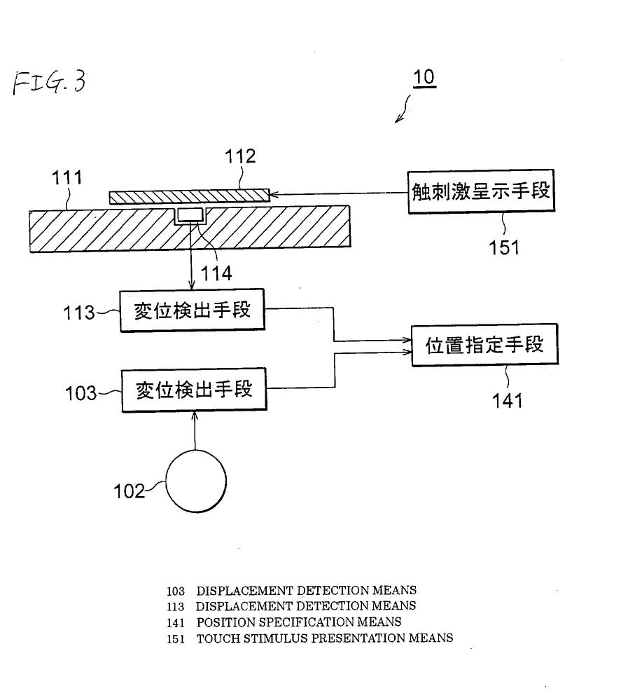

FIG. 3 is a block diagram of the device 100 including the stimulus presentation section 14. In the figure, the fixed member 111 and the moving member 112 are shown as a sectional view. The fixed member 111 and the moving member 112 are roughly shaped each like a flat plate, and the moving member 112 can move relative to the fixed member 111. The move direction of the moving member 112 is a parallel direction to the plane of the fixed member 111, and the moving member 112 can also rotate on the plane. Second displacement detection means 113 detects displacement (move direction and move distance) of the moving member 112 relative to the fixed member 111 together with a position detection sensor 114.

Position specification means 141 finds information of an input command concerning a position, given by the operator in response to displacement of the main unit section 101 detected by the first displacement detection means 103 and displacement of the moving member 112 detected by the second displacement detection means 113, and sends the information to the main unit section 11. This operation is based on the pointing function of the device 100. Touch stimulus presentation means 151 moves the moving member 112 relative to the fixed member 111, thereby presenting a touch stimulus to a finger, etc., of the operator touching the top of the moving member 112.

From the device 100 to the main unit section 11, the finally specified position information may be transmitted or the displacement of the main unit section 101 detected by the first displacement detection means 103 and the displacement of the moving member 112 detected by the second displacement detection means 113 may be transmitted. In the latter case, the position specification means 141 of the device 100 exists in the main unit section 11.

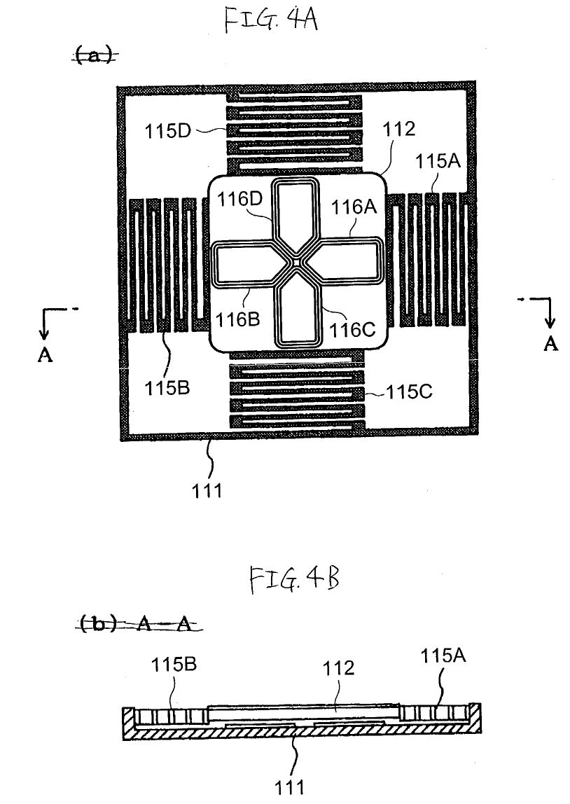

FIGS. 4A and 4B are more detailed configuration drawings of the fixed member 111 and the moving member 112 of the device 100 including the stimulus presentation section 14. FIG. 4A is a plan view and FIG. 4B is a sectional view taken on line A-A in FIG. 4A. The device 100 has the fixed member 111 shaped roughly like a flat plate with margins projecting upward, the moving member 112 that can move in a parallel direction to a predetermined plane relative to the fixed member 111, and elastic members 115A to 115D being placed between the margins of the fixed member 111 and the moving member 112 for joining the fixed member 111 and the moving member 112. The elastic members 115A to 115D are each an elastic resin, an elastic spring, etc., and are placed at four positions surrounding the moving member 112, each elastic member with one end joined to the moving member 112 and an opposite end joined to the margin of the fixed member 111.

Four coils 116A to 116D are fixed to the moving member 112. In FIG. 4A (plan view), letting the center be the origin, the right direction be an X axis direction, and the up direction be a Y axis direction, the coil 116A is placed straddling the X axis in an area with positive X coordinate values; the coil 116B is placed straddling the X axis in an area with negative X coordinate values; the coil 116C is placed straddling the Y axis in an area of positive Y coordinate values; and the coil 116D is placed straddling the Y axis in an area with negative Y coordinate values.

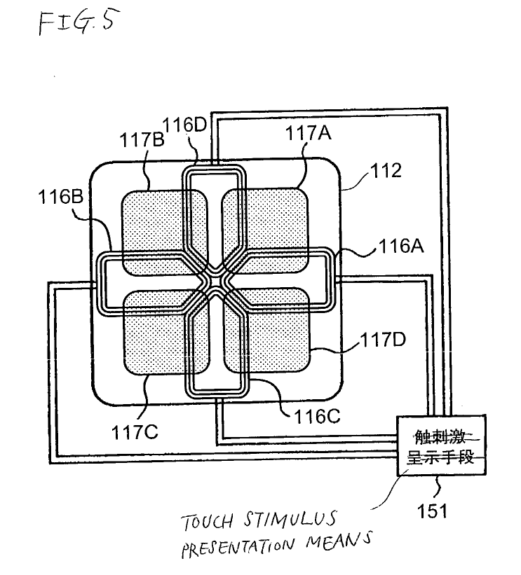

FIG. 5 is a plan view to describe a touch stimulus presentation mechanism in the device 100 including the stimulus presentation section 14. Four magnets 117A to 117D are fixed to the fixed member 111. The magnet 117A is placed in an area with positive X coordinate values and positive Y coordinate values so that a magnetic flux of the magnet 117A pierces both the coils 116A and 116D. The magnet 117B is placed in an area with negative X coordinate values and positive Y coordinate values so that a magnetic flux of the magnet 117B pierces both the coils 116B and 116D. The magnet 117C is placed in an area with negative X coordinate values and negative Y coordinate values so that a magnetic flux of the magnet 117C pierces both the coils 116B and 116C. The magnet 117D is placed in an area with positive X coordinate values and negative Y coordinate values so that a magnetic flux of the magnet 117D pierces both the coils 116A and 116C. The magnets 117A and 117C are placed so that the side opposed to the moving member 112 becomes the S pole; the magnets 117B and 117D are placed so that the side opposed to the moving member 112 becomes the N pole.

In other words, the relative positional relationships among the coils 116A to 116D and the magnets 117A to 117D are as follows: The coil 116A is placed so that an electric current crosses magnetic fields produced by the magnets 117A and 117D in a parallel direction to the X axis. The coil 116B is placed so that an electric current crosses magnetic fields produced by the magnets 117B and 117C in a parallel direction to the X axis. The coil 116C is placed so that an electric current crosses magnetic fields produced by the magnets 117C and 117D in a parallel direction to the Y axis. The coil 116D is placed so that an electric current crosses magnetic fields produced by the magnets 117A and 117B in a parallel direction to the Y axis.

As each of the coils 116A to 116D, a copper wire may be used or an aluminum wire may be used for weight reduction or use of a copper-plated aluminum wire is preferred. Preferably, each of the magnets 117A to 117D has a large coercivity and a large residual magnetic flux density; for example, a NdFeB magnet is preferred.

The touch stimulus presentation means 151 can cause an electric current to flow into each of the coils 116A to 116D separately. Interaction responsive to the Fleming's left-hand rule occurs between the magnitude and direction of the electric current flowing into each of the coils 116A to 116D and the magnetic field produced by each of the magnets 117A to 117D. Accordingly, thrust occurs in each of the coils 116A to 116D, and the moving member 112 moves relative to the fixed member 111 in response to the thrust and the stresses of the elastic members 115A to 115D. As the moving member 112 moves, a touch stimulus is presented to a finger, etc., of the operator touching the top of the moving member 112.

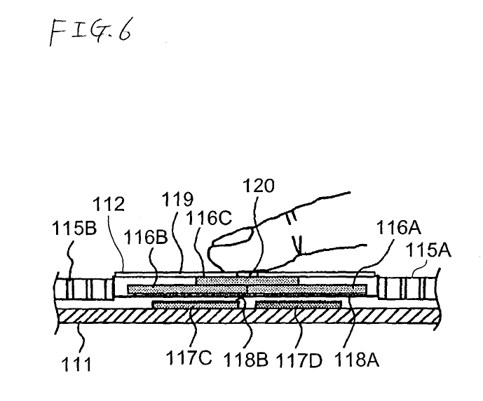

FIG. 6 is a sectional view to describe a slide mechanism of the fixed member 111 and the moving member 112 in the device 100 including the stimulus presentation section 14. Slide members 118B and 118A are placed on the upper face of the fixed member 111 where the coils 116A to 116D are fixed and the lower face of the moving member 112 where the coils 116A to 116D are fixed so as to enable the fixed member 111 and the moving member 112 to slide each other. As each of the slide members 118A and 118B, fluorocarbon resin having a small friction coefficient (for example, polytetrafluoroethylene, etc.,), lubricating-oil-impregnated resin, metal, etc., is used preferably. Applying lubricating oil between the slide members 118A and 118B is also preferred, and a sphere of a non-magnetic substance maybe made to intervene and maybe rolled for sliding.

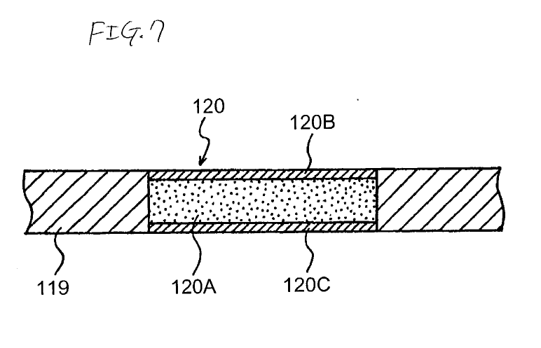

FIG. 6 shows not only the slide mechanism, but also a surface layer 119 on the upper face of the moving member 112 and a pressure-sensitive part 120 placed in the vicinity of the center of the surface layer 119. FIG. 7 is a sectional view to describe the pressure-sensitive part 120 in the device 100 including the stimulus presentation section 14. The surface layer 119 has a flat finish so as to enable a receptor of a finger, a palm, etc., of a human being to come in and out of contact with the surface layer 119. The pressure-sensitive part 120 detects a finger, etc., of a human being touching the surface layer 119. The pressure-sensitive part 120 has pressure-sensitive conductive rubber 120A using a mixture material of silicone rubber and conductive powder, sandwiched between conductive plastic layers 120B and 120C. A voltage is applied between the conductive plastic layers 120B and 120C, and change in the electric resistance value caused by the touch pressure produced when a finger, etc., of a human being touches the pressure-sensitive part 120, whereby presence or absence of touch is detected. A touch detection signal output from the pressure-sensitive part 120 is sent to the touch stimulus presentation means 151 and when touch is acknowledged, the moving member 112 is driven by the touch stimulus presentation means 151.

In addition, other methods of detecting a finger, etc., of a human being touching the moving member 112 are as follows: Preferably, the moving member 112 is provided with a charge storage section for storing and holding predetermined charges and when a finger, etc., of a human being touches the moving member 112, the charges held in the charge storage section are allowed to flow into the finger, etc., of the human being and change in the amount of the charges stored in the charge storage section is detected, thereby detecting the finger, etc., of the human being touching the moving member 112. Preferably, two electrodes having flexibility are supported so that the distance therebetween becomes constant, and when a finger, etc., of a human being touches the moving member 112, the distance between the two electrodes changes and change in the electrostatic capacity existing between the electrodes is detected, thereby detecting the finger, etc., of the human being touching the moving member 112. Further, preferably a light reception element is placed on the upper face of the moving member 112 and a light reception element is also placed on the upper face of the margin of the fixed member 111 and lowering of the value of an output signal from the light reception element on the upper face of the moving member 112 is detected based on change in the values of output signals from the light reception elements, thereby detecting a finger, etc., of a human being touching the moving member 112.

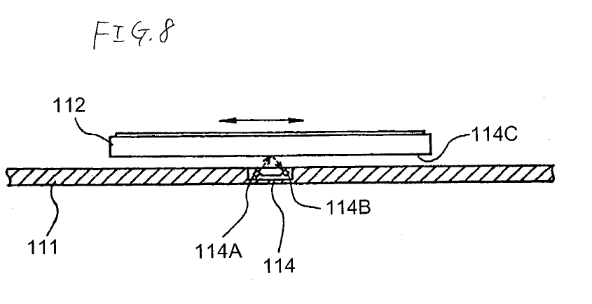

FIG. 8 is a sectional view to describe the position detection sensor 114 in the device 100 including the stimulus presentation section 14. The position detection sensor 114 includes a light emission element (for example, a light emitting diode) 114A and a light reception element (for example, a photodiode) 114B fixed to the fixed member 111 and an optical pattern (for example, equally spaced light and shade pattern, checks, etc.,) 114C drawn on the lower face of the moving member 112. Light emitted from the light emission element 114A is applied onto the optical pattern 114C and light reflected on the optical pattern 114C is received by the light reception element 114B. The light reception amount of the light reception element 114B is responsive to the reflection factor at the position where the light emitted from the light emission element 114A is incident on the optical pattern 114C.

Therefore, the displacement amount of the moving member 112 relative to the fixed member 111 can be detected based on change in the electric signal output from the light reception element 114B in response to the light reception amount. One position detection sensor 114 is placed in the X axis direction and another position detection sensor 114 is placed in the Y axis direction, whereby the two-dimensional displacement amount of the moving member 112 relative to the fixed member 111 can be detected. The output signal from the position detection sensor 114 is sent to the second displacement detection means 113, which then detects displacement of the moving member 112.

In addition, other methods of detecting displacement of the moving member 112 are as follows: Preferably, laser light is applied to fine asperities formed on the lower face of the moving member 112 to produce a speckle pattern, and this speckle pattern is observed by a two-dimensional image sensor, whereby the two-dimensional displacement amount of the moving member 112 relative to the fixed member 111 is detected. Preferably, a rotation body for touching the moving member 112 is placed and the rotation amount of the rotation body is detected by an encoder, whereby the displacement amount of the moving member 112 relative to the fixed member 111 is detected. Further, preferably either of the fixed member 111 and the moving member 112 is provided with a light emission element and the other is provided with a two-dimensional optical position detection element (PSD: Position sensitive detector), whereby the two-dimensional displacement amount of the moving member 112 relative to the fixed member 111 is detected.

Next, the touch stimulus presentation operation of the stimulus presentation section 14 included in the device 100 will be discussed. When the moving member 112 is driven by the touch stimulus presentation means 151 and an electric current flows into each of the coils 116A to 116D, thrust acts on each of the coils 116A to 116D according to the Fleming's left-hand rule, whereby the moving member 112 moves.

To begin with, considering the coils 116A and 116B, a magnetic field occurs in a Z axis direction of a direction perpendicular to the fixed member 111 and when an electric current flows in the X axis direction in the magnetic field, thrust in the Y axis direction occurs. When an electric current is allowed to flow into the coil 116A clockwise, thrust in the +Y axis direction acts on the coil 116A. When an electric current is allowed to flow into the coil 116B counterclockwise, thrust in the +Y axis direction acts on the coil 116B. As the current flow direction is changed, the thrust acting direction can be changed. As the current value is changed, the magnitude of the thrust can be changed.

Likewise, considering the coils 116C and 116D, a magnetic field occurs in the Z axis direction of a direction perpendicular to the fixed member 111 and when an electric current flows in the Y axis direction in the magnetic field, thrust in the X axis direction occurs. When an electric current is allowed to flow into the coil 116C clockwise, thrust in the +X axis direction acts on the coil 116C. When an electric current is allowed to flow into the coil 116D counterclockwise, thrust in the +X axis direction acts on the coil 116D. As the current flow direction is changed, the thrust acting direction can be changed. As the current value is changed, the magnitude of the thrust can be changed.

If the moving member 112 may be moved only in parallel with the fixed member 111, the coils 116A and 116B may be connected for giving thrust in the same direction to the coils 116A and 116B, and the coils 116C and 116D may be connected for giving thrust in the same direction to the coils 116C and 116D.

Thrust can also be produced in the direction of rotating the moving member 112 relative to the fixed member 111 with the Z axis almost as the center. That is, if an electric current is allowed to flow into the coils 116A and 116B clockwise, thrust in the +Y axis direction acts on the coil 116A and thrust in the −Y axis direction acts on the coil 116B, so that rotation moment of counterclockwise rotating the moving member 112 relative to the fixed member 111 is produced. If an electric current is allowed to flow into the coils 116A and 116B counterclockwise, thrust in the −Y axis direction acts on the coil 116A and thrust in the +Y axis direction acts on the coil 116B, so that rotation moment of clockwise rotating the moving member 112 relative to the fixed member 111 is produced. As the ratio between the values of the electric currents flowing into the coils 116A and 116B is changed, the rotation center can be changed. A similar description is also applied to the coils 116C and 116D.

A move of the moving member 112 is driven by the electric current supplied by the touch stimulus presentation means 151 to each of the coils 116A to 116D. To perform control at the time, for example, PD control (proportional-plus-derivative control) performed in response to position deviation and the differentiation amount of position deviation is used.

Referring again to FIG. 1, the configuration of the management apparatus 30 will be discussed. The management apparatus 30 is a server installed in an Internet service provider, for example, and has a web site that can be accessed by the information processing apparatus 10 and 20 through the Internet. The management apparatus 30 includes common image display management means 31, relation giving means 32, and correlation stimulus presentation means 33.

The common image display management means 31 transmits image data in the website to the information processing apparatus 10 and 20 in response to requests received from the information processing apparatus 10 and 20, and causes the image display sections 13 and 23 to display a common image. The request from the information processing apparatus 10 is made as the input section 12 accepts an input command of the operator A indicating access to a specific web site and the main unit section 11 transmits a signal of the input command accepted by the input section 12 to the management apparatus 30. Likewise, the request from the information processing apparatus 20 is made as the input section 22 accepts an input command of the operator B indicating access to a specific web site and the main unit section 21 transmits a signal of the input command accepted by the input section 22 to the management apparatus 30. Before this, the operators A and B previously determine access to the specific web site and the access time by mail, telephone, etc. The common image is a screen of a web site of shopping, learning, etc., for example.

The relation giving means 32 first executes user recognition, for example, based on the registration numbers and the passwords input by the operators A and B to the input sections 12 and 22 or the IP addresses of the information processing apparatus 10 and 20. The relation giving means 32 relates an input command to the input section 12 concerning a first position in the common image displayed on the image display section 13 and an input command to the input section 22 concerning a second position in the common image displayed on the image display section 23 to each other. The input command concerning the position in the common image displayed on the image display section 13, 23 is given using the pointing function of the device 100. The input commands are related to each other if a combination of the registration information (registration number, password, IP address, etc.,) in each of the information processing apparatus 10 and 20 is registered.

When the input commands to the input sections 12 and 22 are related to each other by the relation giving means 32, the correlation stimulus presentation means 33 causes the stimulus presentation sections 14 and 24 each to present a touch stimulus responsive to the correlation between the first and second positions in the common images displayed on the image display sections 13 and 23. The correlation refers to the spacing between the first and second positions and the direction from either of the first and second positions to the other. The touch stimulus responsive to the correlation refers to the thrust of the moving member 112 of the magnitude responsive to the spacing and the thrust of the moving member 112 in the direction responsive to the above-mentioned direction, for example.

Preferably, when the input commands to the input sections 12 and 22 are related to each other by the relation giving means 32, the common image display management means 31 causes the image display sections 13 and 23 to display image information responsive to the correlation on the common images displayed on the image display sections 13 and 23. The image information responsive to the correlation refers to a virtual rope connecting a first avatar displayed at the first position on the common image and a second avatar displayed at the second position on the common image; it is an image like the slack rope when the spacing between the first and second positions is small; it is an image like the strained rope when the spacing is large. The first avatar is an identification mark indicating that the operator A points to the first position on the common image using the pointing function of the input section 12. The second avatar is an identification mark indicating that the operator B points to the second position on the common image using the pointing function of the input section 22.

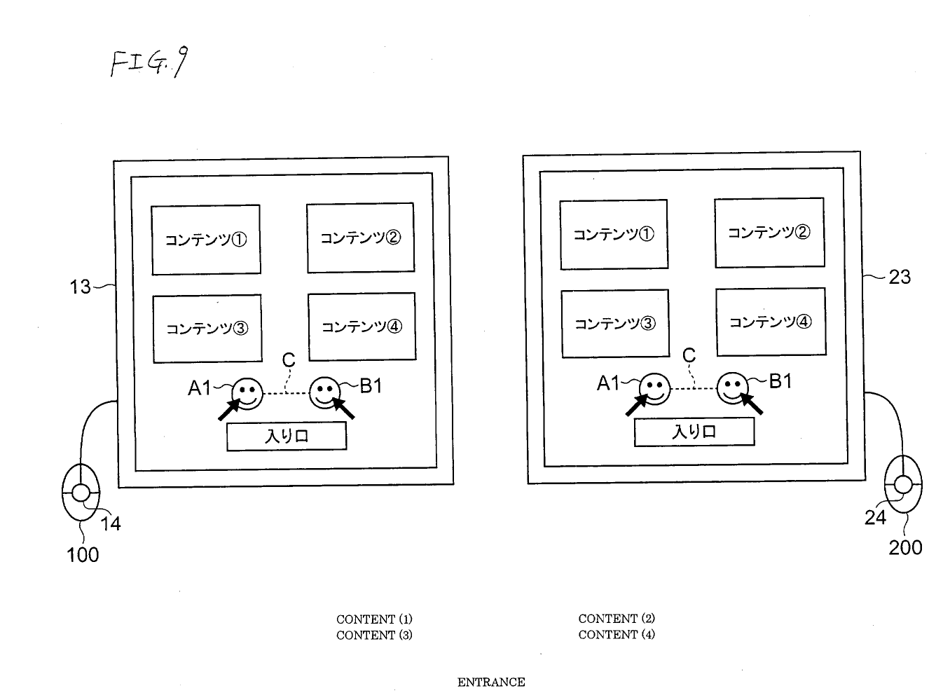

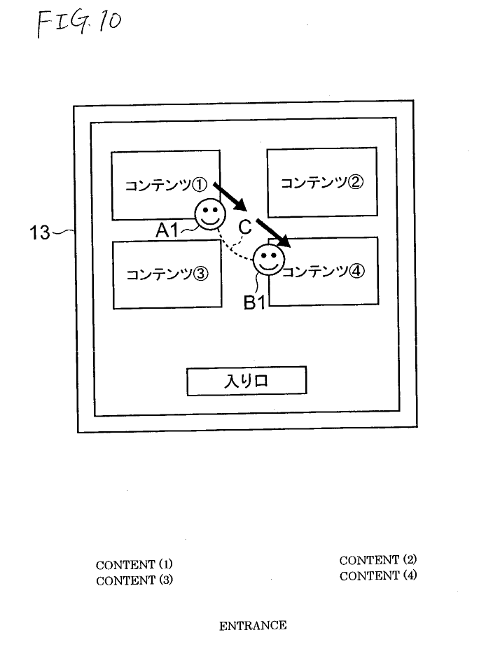

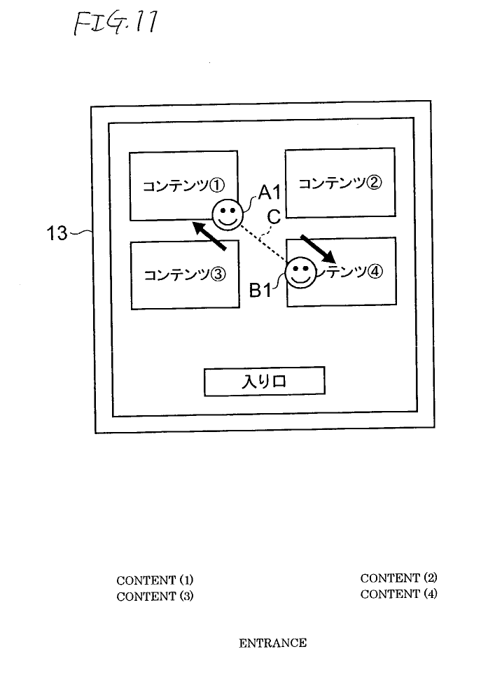

Next, the operation of the information processing system 1 according to the embodiment and the information processing method according to the embodiment will be discussed more specifically with reference to FIGS. 9 to 11. FIG. 9 is a drawing to show an example of the common images displayed on the image display sections 13 and 23. FIGS. 10 and 11 are each a drawing to show an example of the common image displayed on the image display section 13.

The operators A and B previously obtain mutual consent about accessing a specific web site on the Internet at a predetermined time. If the operator A gives an input command indicating accessing the specific web site at the predetermined time to the input section 12 of the image processing apparatus 10, a signal of the input command is sent from the image processing apparatus 10 via the network to the management apparatus 30. Likewise, if the operator B gives an input command indicating accessing the specific web site at the predetermined time to the input section 22 of the image processing apparatus 20, a signal of the input command is sent from the image processing apparatus 20 via the network to the management apparatus 30. Based on the requests from the image processing apparatus 10, 20, the common image display management means 31 of the management apparatus 30 transmits image data in the specific web site to the image processing apparatus 10 and 20 for displaying common images the image display sections 13 and 23.

The relation giving means 32 executes user recognition as follows: As shown in FIG. 9, as the operator A operates the pointing function of the device 100, his or her avatar A1 passes through “entrance” in the common image displayed on the image display section 13, and the operator A enters registration information in the input section 12. As the operator B operates the pointing function of a device 200 (which has a similar configuration to that of the device 100 and is included in the image processing apparatus 20), his or her avatar B1 passes through “entrance” in the common image displayed on the image display section 23, and the operator B enters registration information in the input section 22. If the combination of the registration information is registered, the relation giving means 32 relates the input command to the input section 12 concerning the first position in the common image displayed on the image display section 13 and the input command to the input section 22 concerning the second position in the common image displayed on the image display section 23 to each other.

The operators A and B are informed that the input commands are related to each other as a virtual rope C connecting the avatars A1 and B1 displayed on the image display sections 13 and 23 is displayed as shown in FIG. 9. After this, the correlation stimulus presentation means 33 causes the stimulus presentation sections 14 and 24 each to present a touch stimulus in response to the correlation between the avatars A1 and B1 in the common images displayed on the image display sections 13 and 23, and the common image display management means 31 displays the strain state of the rope C.

For example, as shown in FIG. 10, when the operator B moves the avatar B1 in the lower-right direction of the image display section 23 by performing pointing operation of the device 200, if the operator A also moves the avatar A1 in the lower-right direction of the image display section 13 by performing pointing operation of the device 100, the distance between the avatar A1 and the avatar B1 in the common image remains small and therefore the thrust presented to the moving member 112 of the stimulus presentation section 14, 24 of the device 100, 200 is small (or does not exist) and the virtual rope C connecting the avatars A1 and B1 slackens.

On the other hand, as shown in FIG. 11, when the operator B moves the avatar B1 in the lower-right direction of the image display section 23, if the operator A also moves the avatar A1 in the upper-left direction of the image display section 13, the distance between the avatar A1 and the avatar B1 in the common image becomes large and therefore the thrust presented to the moving member 112 of the stimulus presentation section 14, 24 is large and the virtual rope C connecting the avatars A1 and B1 is strained. At this time, the thrust of the moving member 112 of the stimulus presentation section 14, 24 acts in the direction in which the avatar of the associated party exists.

It is also preferred that the avatar B1 moves actively and the avatar A1 moves passively following the move of the avatar B1. That is, if the operator B presses the moving member 112 of the device 200 comparatively strongly, the switch 131 is pressed and in this state, if the operator B performs pointing operation of the device 200, the avatar B1 moves actively on the common images displayed on the image display sections 13 and 23. On the other hand, if the operator A touches the moving member 112 of the device 100 softly with a finger, the avatar A1 moves passively following the move of the avatar B1. That is, the operator B of the active party can move the avatar B1 as he or she intends, and can report his or her intention to the operator A. On the other hand, the avatar A1 of the operator A of the passive party moves following the move of the avatar B1 of the operator B of the active party and thus a touch stimulus is not presented by the moving member 112 to the operator B, so that the operator B is informed that the avatar A1 of the operator A of the passive party follows the avatar B1.

It is also preferred that both the avatars A1 and B1 move actively. That is, if the operator B presses the moving member 112 of the device 200 comparatively strongly, the switch 131 is pressed and in this state, if the operator B performs pointing operation of the device 200, the avatar B1 moves actively on the common images displayed on the image display sections 13 and 23. Likewise, if the operator A also presses the moving member 112 of the device 100 comparatively strongly, the switch 131 is pressed and in this state, if the operator A performs pointing operation of the device 100, the avatar A1 moves actively on the common images displayed on the image display sections 13 and 23. At this time, thrust acts on the moving members 112 of the devices 100 and 200 in response to the correlation between the avatars A1 and B1 in the common images displayed on the image display sections 13 and 23, and the strain state of the rope C is displayed on the image display sections 13 and 23. That is, the operators A and B can move the avatars actively as they intend, and can report their intentions to each other.

As described above, according to the information processing system 1 according to the embodiment or the information processing method according to the embodiment, common images are displayed on the image display sections 13 and 23 of the image processing apparatus 10 and 20 placed in the operators A and B, and the input command to the input section 12 concerning the first position in the common image displayed on the image display section 13 and the input command to the input section 22 concerning the second position in the common image displayed on the image display section 23 are related to each other. After this, the stimulus presentation sections 14 and 24 are caused each to present a touch stimulus in response to the correlation between the avatars A1 and B1 in the common images displayed on the image display sections 13 and 23, and the strain state of the rope C is displayed on the image display sections 13 and 23. That is, in response to the input command to the input section given by either of the operators A and B, the stimulus presentation section gives a touch stimulus to the other operator, and the image display section displays the strain state of the rope C for this operator. Therefore, if the operators A and B are at a distance from each other, they can understand the object in which the associated party takes interest on the common image displayed on the image display section 13, 23, and they can have information in common. The operators A and B can be involved in shopping or learning while holding information in common on the Internet, so that “enjoyment” and “easiness to understand” grow.

Next, specific application examples of the information processing system 1 according to the embodiment or the information processing method according to the embodiment will be discussed.

A first application example is shopping of operators A and B (a pair of lovers, husband and wife, parent and child, grandfather and grandchild, etc.,) on the Internet. In this case, the common image displayed on the image display section 13, 23 is an image in a web site of Internet shopping, and several objects indicating commodities are displayed. The operator B can move his or her avatar B1 actively by the pointing function of the device 200, thereby informing the operator A of the commodity in which the operator B takes interest through the moving member 112 of the device 100. In response to this, the operator A places his or her avatar A1 in a passively movable state, whereby the operator A can know the commodity in which the operator B takes interest according to the avatar position on the image display section 13. Thus, if the operators A and B are at a distance from each other, they can enjoy shopping while communicating with each other.

For example, if the operator B is a grandchild and the operator A is a grandfather, namely, if the person who has purchase moneys is the operator A although the person who wants to buy is the operator B, the Internet shopping in the first application example is preferred. In this case, the operator B can inform the operator A of the commodity to buy and the operator A can buy the commodity in response to the request from the operator B. Alternatively, the operator A can also approve the commodity purchase of the operator B. The event is advantageous for the Internet service provider running the web site because two persons access the web site at the same time. For the shopper opening the web site of shopping, the possibility of commodity purchase is increased and there is a possibility that the profits will increase because two persons access the web site at the same time.

The shopper can charge the operator A who has purchase moneys for the commodity as in the example of grandfather and grandchild. If the operator B is a grandchild who is a minor and the operator A is an adult as in the example, the shopper may automatically charge the operator A for the commodity. It is also preferred that the shopper charges either the operator A or B for the commodity based on the previously registered customer information. To do this, preferably the management apparatus 30 further includes charging management means for charging either of the operators A and B based on the previously registered information concerning charging of the operators. The expression “information concerning charging of the operators” mentioned here is used to mean information indicating that the operator B is a minor and the operator A is an adjust in the example or information indicating which of operators is to be charged in a combination of specific operators A and B.

A second application example is mutual guidance of operators A and B (classmates, teacher and pupil, grandfather and grandchild, etc.,) on the Internet. In this case, the common image displayed on the image display section 13, 23 may be an image in any web site. The operator B can move his or her avatar B1 actively, thereby informing the operator A of the trouble part of the operator B. In response to this, the operator A places his or her avatar A1 in a passively movable state, whereby the operator A can know the trouble part of the operator B. Consequently, the active and passive situations are exchanged and the operator A can move his or her avatar A1 actively, thereby informing the operator B of the part to be clicked by the operator B to solve the trouble of the operator B. In response to this, the operator B places his or her avatar B1 in a passively movable state, whereby the operator B can know the click part indicated by the operator A. Thus, if the operators A and B are at a distance from each other, they can mutually provide guidance while communicating with each other, and can enjoy the web site through the mutual guidance.

Hitherto, the operator B who does not know operation on the web site has received support of the information provider by telephone, etc. In the application example, however, the operator B can receive support of the operator A who is familiar with the operation. This is advantageous for the Internet service provider running the web site because there is a possibility that the layer of persons the Internet service provider cannot bring over to the web site may access the web site. The support work load on the information provider opening the web site is lightened because the operators A and B of the users support each other.

If either of the operators A and B thus operates actively and the other operates passively, preferably the management apparatus 30 further includes master and slave relationship giving means for setting such relationship of master and slave.

In the described embodiment, the system has the two information processing apparatus 10 and 20 connected to the network, but may have three or more information processing apparatus connected to the network. If N (N is an integer of three or more) information processing apparatus each having the described configuration are connected to the network, the nth operator operating the nth information processing apparatus (n is each integer ranging from 1 to N) can receive a touch stimulus responsive to the input command position of each operator on the common image and can have information in common if the operator is at a distance from any other operator.

As described above in detail, according to the invention, the first operator and the second operator can see the common images displayed on the first image display section and the second image display section by the common image display management means. The relation giving means relates the input command to the first input section given by the first operator concerning the first position in the common image and the input command to the second input section given by the second operator concerning the second position in the common image to each other. The correlation stimulus presentation means causes the first stimulus presentation section and the second stimulus presentation section each to present the touch stimulus responsive to the correlation between the first position and the second position in the common images, so that the first operator and the second operator can each receive the touch stimulus responsive to the correlation. Thus, the first operator and the second operator can receive the touch stimulus responsive to the input command position of the associated party relative to the input command position on the common image and can have information in common if they are at a distance from each other.

Referring now to the accompanying drawings, there are shown preferred embodiments of an information processing system and an information processing method according to the invention. In the drawings, the same elements are denoted by the same reference numerals and duplicate description is omitted. The dimension ratios of the drawings do not always match those in the description that follows.

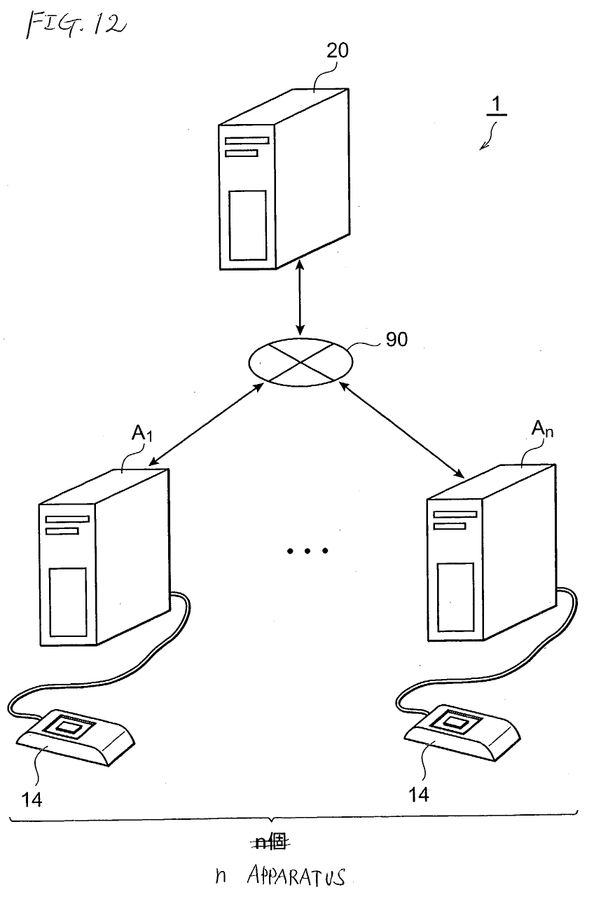

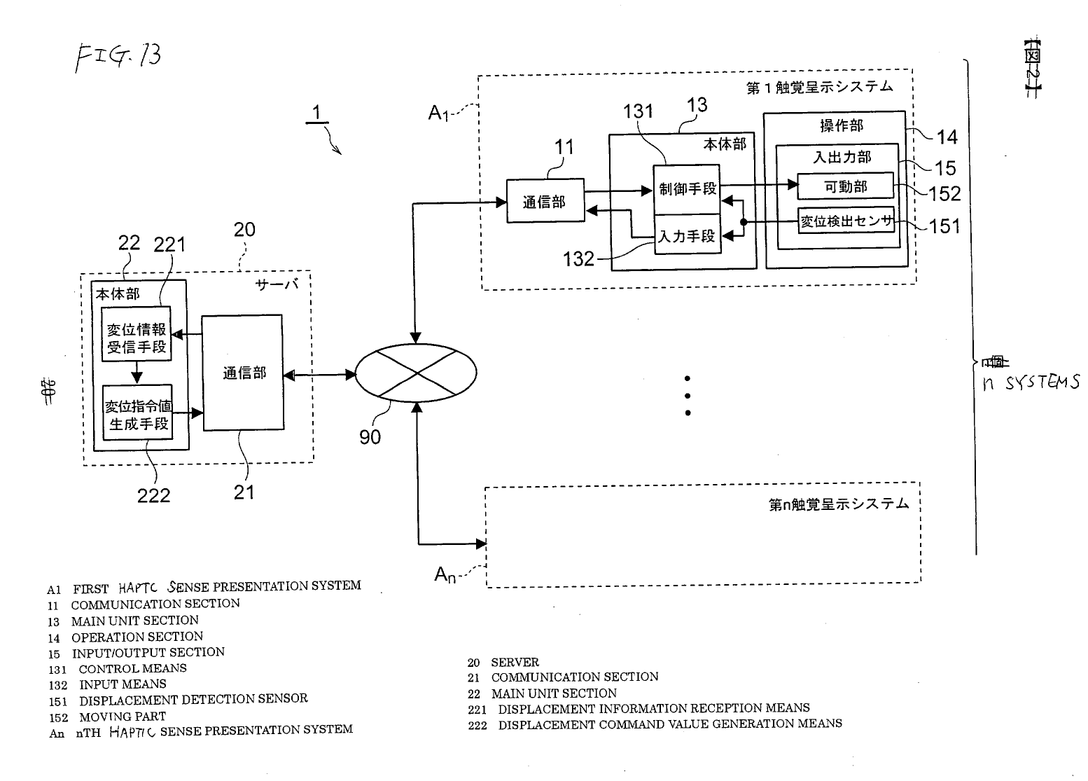

FIG. 12 is a general view to show an embodiment of an information processing system 1 according to the invention. FIG. 13 is a block diagram to show the internal configuration of the information processing system 1 shown in FIG. 12. The information processing system 1 is made up of a first haptic sense presentation system A1 to an Nth haptic sense presentation system An (where N is an integer of two or more) and a server 20. The first haptic sense presentation system A1 to the Nth haptic sense presentation system An and the server 20 are connected to each other through a network 90. The internal configurations of the first haptic sense presentation system A1 and the server 20 will be discussed below. The internal configuration of each of second haptic sense presentation system A2 (not shown) to the Nth haptic sense presentation system An is similar to that of the first haptic sense presentation system A1 and therefore will not be discussed or shown again.

The first haptic sense presentation system A1 is made up of a communication section 11 of a first communication section, a main unit section 13, and an operation section 14. The communication section 11 is connected to the server 20 through the network 90, and communicates with a communication section 21 of the server 20 in a predetermined period.

The operation section 14 has an input/output section 15. The input/output section 15 displaces a moving part 152, thereby presenting a haptic sense to a fingertip, etc., of a first operator operating the first haptic sense presentation system A1. The input/output section 15 also receives input of displacement of the moving part 152 with the fingertip of the first operator. The displacement of the moving part 152 is detected by a displacement detection sensor 151 of a displacement detection section, and first displacement information indicating the displacement of the moving part 152 of the first haptic sense presentation system A1 is sent to the main unit section 13. The configuration of the operation section 14 is described later in detail.

The main unit section 13 includes a CPU (Central Processing Unit), ROM (Read-Only Memory), RAM (Random Access Memory), etc., and controls input/output of various pieces of information by the communication section 11 and the operation section 14 and performs computation based on the information. For this purpose, the main unit section 13 has control means 131 and input means 132. These means are implemented as the CPU reads and executes programs stored in the ROM, etc., contained in the main unit section 13.

The input means 132 inputs the first displacement information from the operation section 14, and outputs the first displacement information to the communication section 11, which then transmits the first displacement information to the server 20 through the network 90.

The server 20 includes a communication section 21 of a second communication section and a main unit section 22. The communication section 21 receives the first displacement information from the first haptic sense presentation system A1. Likewise, the communication section 21 receives second displacement information to Nth displacement information from the second haptic sense presentation system A2 to the Nth haptic sense presentation system An respectively. Then, the communication section 21 sends the displacement information to the main unit section 22.

The main unit section 22 includes a CPU, ROM, RAM, etc., and controls input/output of various pieces of information by the communication section 21 and performs computation based on the information. For this purpose, the main unit section 22 has displacement information reception means 221 and displacement command value generation means 222. These means are implemented as the CPU reads and executes programs stored in the ROM, etc., contained in the main unit section 22.

The displacement information reception means 221 inputs the first displacement information to the Nth displacement information through the network 90 and the communication section 21. After all the displacement information is complete, the displacement information reception means 221 outputs the displacement information to the displacement command value generation means 222.

The displacement command value generation means 222 inputs the first displacement information to the Nth displacement information from the displacement information reception means 221, and generates a first displacement command value to be sent to the first haptic sense presentation system to an Nth displacement command value to be sent to the Nth haptic sense presentation system. As a generation method of the displacement command values, for example, when N=2, the first displacement command value may be generated based on the second displacement information and the second displacement command value may be generated based on the first displacement information. For example, the following expressions (1) and (2) may be used for calculation:

X1r=X2 (1)

X2r=X1 (2)

(where X1r and X2r are first and second displacement command values concerning the X axis of the moving part 152 and X1 and X2 are first displacement information and second displacement information concerning the X axis of the moving part 152) whereby the first displacement command value and the second displacement command value may be generated.

When N≧3, the Kth displacement command value (where K is an integer ranging from 1 to N) may be generated based on other displacement information pieces than the Kth displacement information in such a manner that the first displacement command value is generated based on the second displacement information to the Nth displacement information. For example, when N=3, the first displacement command value to the third displacement command value may be generated by calculation according to the following expressions (3) to (5):

X1r=(X2+X3)/2 (3)

X2r=(X1+X3)/2 (4)

X3r=(X1+X2)/2 (5)

(where X1r to X3r are first to third displacement command values concerning the X axis of the moving part 152 and X1 to X3 are first displacement information to third displacement information concerning the X axis of the moving part 152). Similar expressions to expressions (1) to (5) may be used to generate the displacement command values concerning the Y axis of the moving part 152.

The displacement command value generation means 222 sends the first displacement command value to the Nth displacement command value thus generated to the communication section 21. The communication section 21 transmits the first displacement command value to the first haptic sense presentation system A1. Likewise, the communication section 21 transmits the second displacement command value to the Nth displacement command value to the second haptic sense presentation system A2 to the Nth haptic sense presentation system An respectively.

The communication section 11 of the first haptic sense presentation system A1 inputs the first displacement command value from the server 20, and outputs the first displacement command value to the control means 131.

The control means 131 inputs the first displacement command value from the communication section 11, and controls the moving part 152 so as to present displacement responsive to the first displacement command value. That is, the control means 131 receives displacement information of the moving part 152 from the displacement detection sensor 151 for detecting displacement of the moving part 152, and performs feedback control for the moving part 152 so that the displacement information follows the displacement command value.

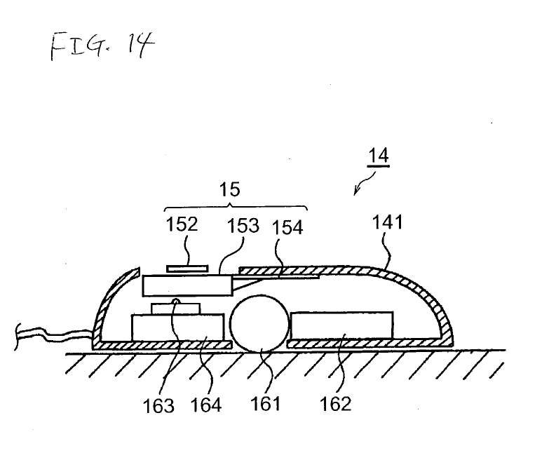

FIG. 14 is a sectional view to show the configuration of the operation section 14. The operation section 14 has a shape roughly similar to that of a traditional mouse. The operation section 14 has the moving part 152, a fixed member 153, and a support member 154 as the input/output section 15. The fixed member 153 is fixed to the top of a main unit 141 via the support member 154 that can elastically bend. The moving part 152 can be displaced in parallel to the fixed member 153. The moving part 152 is displaced actively, thereby presenting a haptic sense to the fingertip, etc., of the first operator touching the moving part 152.

The operation section 14 has a switch 163 and a signal processing circuit 164. As the moving part 152 is pressed with the finger, etc., of the first operator operating the operation section 14, the fixed member 153 presses the switch 163. The signal processing circuit 164 outputs a signal indicating that the moving part 152 is pressed.

The operation section 14 further includes a ball 161 and rotation amount detection means 162. The ball 161 is on the bottom of the main unit 141 and can rotate. As the main unit 141 moves on a reference surface (for example, a desktop surface or a mouse pad), the ball 161 rotates. The rotation amount detection means 162 is implemented as a rotation angle measurement device such as an encoder, for example, and detects the rotation direction and the rotation amount of the ball 161.

The switch 163, the signal processing circuit 164, the ball 161, and the rotation amount detection means 162 do not directly act on haptic sense communication of the input/output section 15 and thus can be used for other various applications.

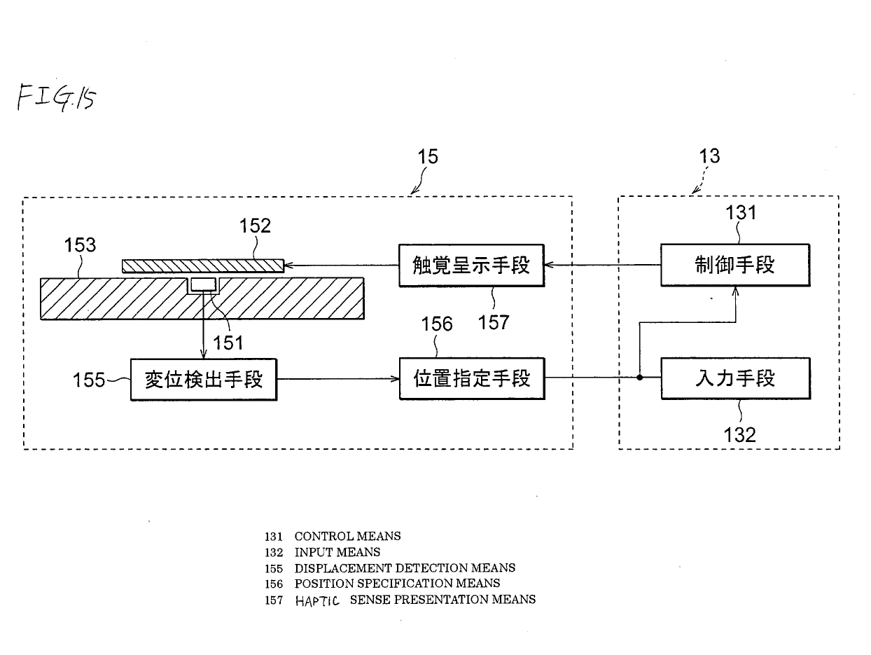

FIG. 15 is a block diagram to show the configuration of the input/output section 15. Displacement detection means 155 detects displacement (move direction and move distance) of the moving part 152 relative to the fixed member 153 together with the displacement detection sensor 151, and outputs the detection result to position specification means 156.

The position specification means 156 adds up the detection results provided continuously by the displacement detection means 155 to find the relative position of the moving part 152 to the fixed member 153, and generates the first displacement information. Then, the position specification means 156 outputs the first displacement information to the control means 131 and the input means 132 contained in the main unit section 13.

The control means 131 outputs a displacement signal of a signal for controlling the moving part 152 to haptic sense presentation means 157, which then moves the moving part 152 relative to the fixed member 153 based on the displacement signal, thereby presenting displacement to the fingertip, etc., of the first operator touching the moving part 152.

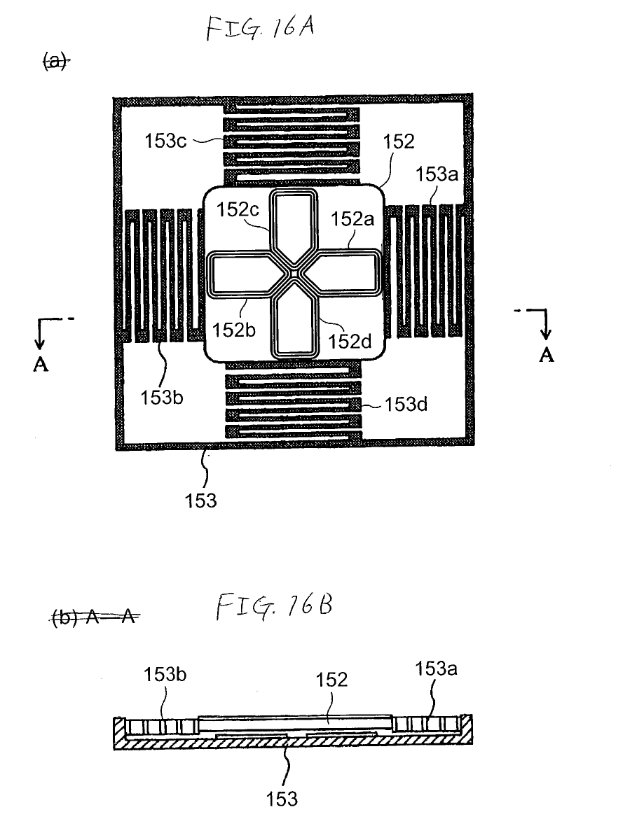

FIGS. 16A and 16B are more detailed configuration drawings of the fixed member 153 and the moving part 152 of the input/output section 15. FIG. 16A is a plan view and FIG. 16B is a sectional view taken on line A-A in FIG. 16A. The input/output section 15 has the fixed member 153 shaped roughly like a flat plate with margins projecting upward, the moving part 152 that can move in a parallel direction to a predetermined plane relative to the fixed member 153, and elastic members 153a to 153d being placed between the margins of the fixed member 153 and the moving part 152 for joining the fixed member 153 and the moving part 152. The elastic members 153a to 153d are each an elastic resin, an elastic spring, etc., and are placed at four positions surrounding the moving part 152. Each of the elastic members 153a to 153d has one end joined to the moving part 152 and an opposite end joined to the margin of the fixed member 153.

Four coils 152a to 152d are fixed to the moving part 152. In FIG. 5A, letting the center be the origin, the right direction be an X axis direction, and the up direction be a Y axis direction, the coil 152a is placed straddling the X axis in an area with positive X coordinate values. The coil 152b is placed straddling the X axis in an area with negative X coordinate values. The coil 152c is placed straddling the Y axis in an area of positive Y coordinate values. The coil 152d is placed straddling the Y axis in an area with negative Y coordinate values.

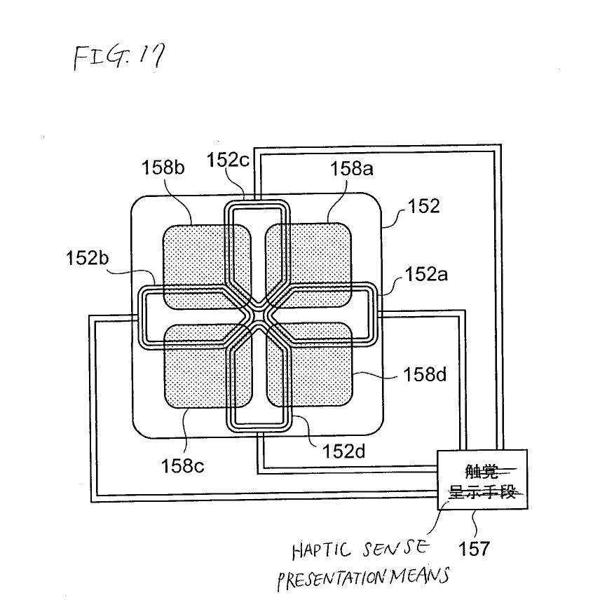

FIG. 17 is a plan view to describe a haptic sense presentation mechanism of the input/output section 15. Four magnets 158a to 158d are fixed to the fixed member 153. The magnet 158a is placed in an area with positive X coordinate values and positive Y coordinate values so that a magnetic flux of the magnet 158a pierces both the coils 152a and 152c. The magnet 158b is placed in an area with negative X coordinate values and positive Y coordinate values so that a magnetic flux of the magnet 158b pierces both the coils 152b and 152c. The magnet 158c is placed in an area with negative X coordinate values and negative Y coordinate values so that a magnetic flux of the magnet 158c pierces both the coils 152b and 152d. The magnet 158d is placed in an area with positive X coordinate values and negative Y coordinate values so that a magnetic flux of the magnet 158d pierces both the coils 152a and 152d. The magnets 158a and 158c are placed so that the side opposed to the moving part 152 becomes the S pole; the magnets 158b and 158d are placed so that the side opposed to the moving part 152 becomes the N pole.

In other words, the relative positional relationships among the coils 152a to 152d and the magnets 158a to 158d are as follows: The coil 152a is placed so that an electric current crosses magnetic fields produced by the magnets 158a and 158d in a parallel direction to the X axis. The coil 152b is placed so that an electric current crosses magnetic fields produced by the magnets 158b and 158c in a parallel direction to the X axis. The coil 152c is placed so that an electric current crosses magnetic fields produced by the magnets 158a and 158b in a parallel direction to the Y axis. The coil 152d is placed so that an electric current crosses magnetic fields produced by the magnets 158c and 158d in a parallel direction to the Y axis.

The haptic sense presentation means 157 can cause an electric current to flow into each of the coils 152a to 152d separately. Interaction responsive to the Fleming's left-hand rule occurs between the magnitude and direction of the electric current flowing into each of the coils 152a to 152d and the magnetic field produced by each of the magnets 158a to 158d. Accordingly, thrust occurs in each of the coils 152a to 152d, and the moving part 152 moves relative to the fixed member 153 in response to the thrust and the stresses of the elastic members 153a to 153d. As the moving part 152 moves, a haptic sense is presented to the fingertip, etc., of the first operator touching the top of the moving part 152.

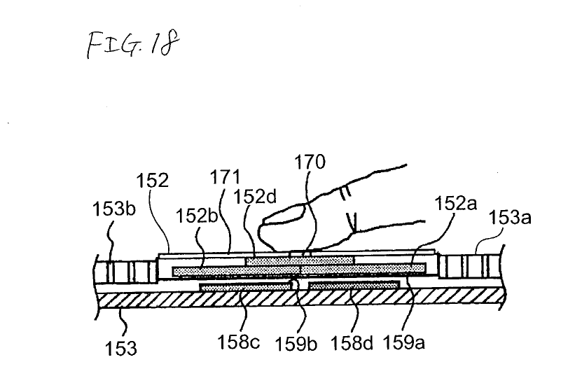

FIG. 18 is a sectional view to describe a slide mechanism of the fixed member 153 and the moving part 152 in the input/output section 15. Slide members 159b and 159a are placed on the upper face of the fixed member 153 where the coils 158a to 158d are fixed and the lower face of the moving part 152 where the coils 152a to 152d are fixed so as to enable the fixed member 153 and the moving part 152 to slide each other. As each of the slide members 159a and 159b, fluorocarbon resin having a small friction coefficient, lubricating-oil-impregnated resin, metal, etc., is used preferably.

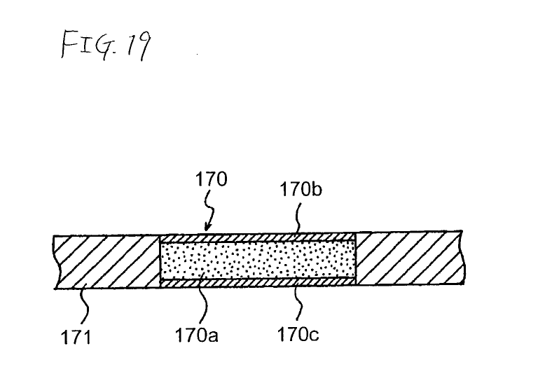

FIG. 18 shows not only the slide mechanism, but also a surface layer 171 on the upper face of the moving part 152 and a pressure-sensitive part 170 placed in the vicinity of the center of the surface layer 171. FIG. 19 is a sectional view to describe the pressure-sensitive part 170 of the operation section 14. The surface layer 171 has a flat finish so as to enable a finger, a palm, etc., of a human being to come in and out of contact with the surface layer 171. The pressure-sensitive part 170 detects a finger, etc., of a human being touching the surface layer 171. The pressure-sensitive part 170 has pressure-sensitive conductive rubber 170a using a mixture material of silicone rubber and conductive powder, sandwiched between conductive plastic layers 170b and 170c. A voltage is applied between the conductive plastic layers 170b and 170c, and change in the electric resistance value caused by the touch pressure produced when a finger, etc., of a human being touches the pressure-sensitive part 170, whereby the strength of touch is detected. The pressure-sensitive part 170 can be used for various applications such as a touch detection section for presenting a haptic sense when the fingertip of the operator touches.

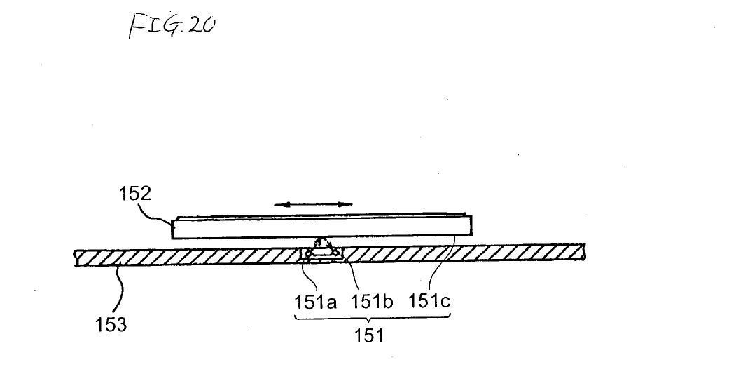

FIG. 20 is a sectional view to describe the displacement detection sensor 151 contained in the input/output section 15. The displacement detection sensor 151 includes a light emission element (for example, a light emitting diode) 151a and a light reception element (for example, a photodiode) 151b fixed to the fixed member 153 and an optical pattern (for example, equally spaced light and shade pattern, checks, etc.,) 151c drawn on the lower face of the moving part 152. Light emitted from the light emission element 151a is applied onto the optical pattern 151c and light reflected on the optical pattern 151c is received by the light reception element 151b. The light reception amount of the light reception element 151b is responsive to the reflection factor at the position where the light emitted from the light emission element 151a is incident on the optical pattern 151c.

Therefore, the displacement amount of the moving part 152 relative to the fixed member 153 can be detected based on change in the electric signal output from the light reception element 151b in response to the light reception amount. One displacement detection sensor 151 is placed in the X axis direction and another displacement detection sensor 151 is placed in the Y axis direction, whereby the displacement amount and the displacement direction of the moving part 152 relative to the fixed member 153 can be detected. The output signal from the displacement detection sensor 151 is sent to the displacement detection means 155, which then adds up the signals to generate the first displacement information.

Here, the haptic sense presentation operation of the input/output section 15 is as follows: When an electric current of a displacement signal flows into each of the coils 152a to 152d by the haptic sense presentation means 157, thrust acts on each of the coils 152a to 152d according to the Fleming's left-hand rule, whereby the moving part 152 moves.

To begin with, considering the coils 152a and 152b, a magnetic field occurs in a Z axis direction of a direction perpendicular to the fixed member 153 and when an electric current flows in the X axis direction in the magnetic field, thrust in the Y axis direction occurs. When an electric current is allowed to flow into the coil 152a clockwise, thrust in the positive direction of the Y axis acts on the coil 152a. When an electric current is allowed to flow into the coil 152b counterclockwise, thrust in the positive direction of the Y axis acts on the coil 152b. As the current flow direction is changed, the thrust acting direction can be changed. As the current value is changed, the magnitude of the thrust can be changed.

Likewise, considering the coils 152c and 152d, a magnetic field occurs in the Z axis direction of a direction perpendicular to the fixed member 153 and when an electric current flows in the Y axis direction in the magnetic field, thrust in the X axis direction occurs. When an electric current is allowed to flow into the coil 152c clockwise, thrust in the positive direction of the X axis acts on the coil 152c. When an electric current is allowed to flow into the coil 152d counterclockwise, thrust in the positive direction of the X axis acts on the coil 152d. As the current flow direction is changed, the thrust acting direction can be changed. As the current value is changed, the magnitude of the thrust can be changed.

If the moving part 152 may be moved only in parallel with the fixed member 153, the coils 152a and 152b may be connected for giving thrust in the same direction to the coils 152a and 152b, and the coils 152c and 152d may be connected for giving thrust in the same direction to the coils 152c and 152d.

Thrust can also be produced in the direction of rotating the moving part 152 relative to the fixed member 153 with the Z axis almost as the center. That is, if an electric current is allowed to flow into the coils 152a and 152b clockwise, thrust in the positive direction of the Y axis acts on the coil 152a and thrust in the negative direction of the Y axis acts on the coil 152b, so that rotation moment of counterclockwise rotating the moving part 152 relative to the fixed member 153 is produced. If an electric current is allowed to flow into the coils 152a and 152b counterclockwise, thrust in the negative direction of the Y axis acts on the coil 152a and thrust in the positive direction of the Y axis acts on the coil 152b, so that rotation moment of clockwise rotating the moving part 152 relative to the fixed member 153 is produced. As the ratio between the values of the electric currents flowing into the coils 152a and 152b is changed, the rotation center can be changed. A similar description is also applied to the coils 152c and 152d.

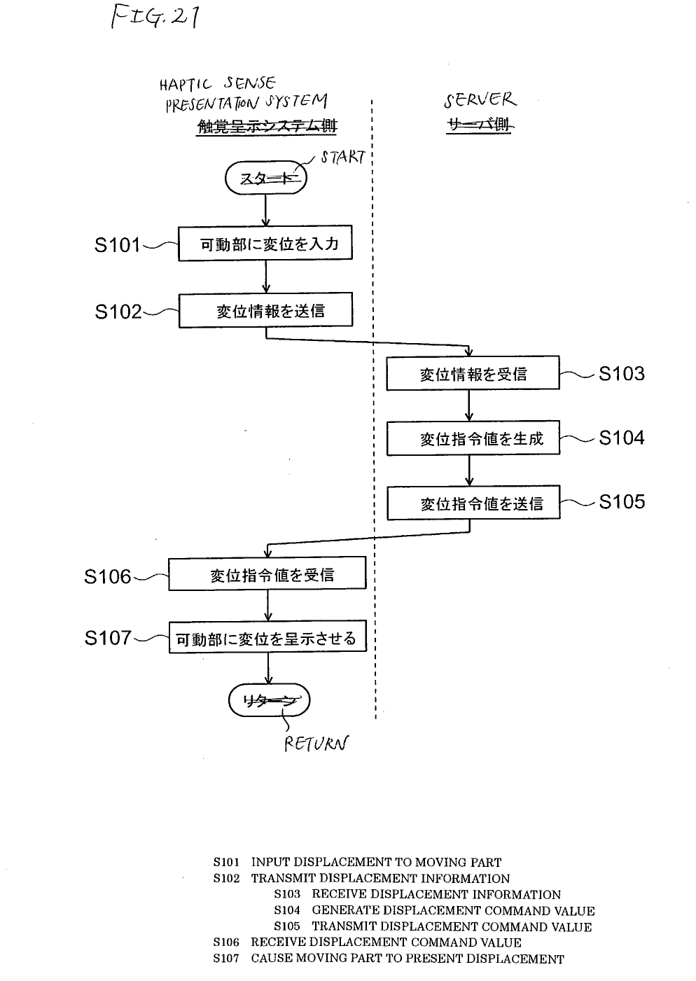

FIG. 21 is a flowchart to show the operation of the information processing system according to the embodiment. An information processing method according to the embodiment will be discussed with FIG. 21. In the information processing system, the haptic sense presentation systems operate almost in the same manner and therefore FIG. 21 shows the operation of only one haptic sense presentation system.

First, the first operator inputs displacement to the moving part 152 of the first haptic sense presentation system A1. Likewise, the second operator to the Nth operator operating the second haptic sense presentation system A2 to the Nth haptic sense presentation system An also input each displacement to the moving parts 152 of the second haptic sense presentation system A2 to the Nth haptic sense presentation system An. The first displacement information to the Nth displacement information indicating the displacements of the moving parts 152 are generated in the input/output sections 15 of the first haptic sense presentation system A1 to the Nth haptic sense presentation system An (displacement detection step, S101).

The first haptic sense presentation systems A1 to An transmit the first displacement information to the Nth displacement information from the communication sections 11 to the server 20 (first communication step, S102). The first displacement information to the Nth displacement information transmitted are received in the communication section 21 of the server 20 (S103).

The communication section 21 of the server 20 sends the first displacement information to the Nth displacement information to the displacement information reception means 221. When the first displacement information to the Nth displacement information are all complete, the displacement information reception means 221 sends the displacement information to the displacement command value generation means 222, which then generates the first displacement command value to the Nth displacement command value based on the first displacement information to the Nth displacement information. At this time, the displacement command value generation means 222 generates the Kth displacement command value based on other displacement information pieces than the Kth displacement information. For example, the displacement command value generation means 222 generates the displacement command values using the calculation method according to expressions (1) and (2) or expressions (3) to (5) described above (displacement command value generation step, S104). The displacement command value generation means 222 sends the first displacement command value to the Nth displacement command value generated to the communication section 21, which then transmits the first displacement command value to the Nth displacement command value to the first haptic sense presentation system A1 to the Nth haptic sense presentation system An respectively (second communication step, S105).

The communication sections 11 of the first haptic sense presentation system A1 to the Nth haptic sense presentation system An receive the first displacement command value to the Nth displacement command value respectively (S106). The communication section 11 of each haptic sense presentation system outputs the received displacement command value to the control means 131. The control means 131 sends a displacement signal to the haptic sense presentation means 157 of the input/output sections 15 according to the input displacement command value. The haptic sense presentation means 157 displaces the moving part 152 for presenting a haptic sense to the operator (control step, S107). After this, control returns to S101 and the above-described process is repeated.

The advantages of the described information processing system and method according to the embodiment will be discussed. In the information processing system and method, the server connected to the network collectively generates the displacement command values for instructing the control means (control step) to displace the moving parts of the N haptic sense presentation systems A1 to An, and sends the displacement command values to the haptic sense presentation systems A1 to An. If the haptic sense presentation systems generate the displacement command values separately as in related arts, it becomes necessary for one haptic sense presentation system to transmit and receive displacement information to and from another haptic sense presentation system. At this time, the larger the number of haptic sense presentation systems, the more enormous the amount of displacement information data communicated on the network. By extension, lowering of the communication speed is incurred and it is made impossible to stably control presentation of a haptic sense in each haptic sense presentation system.

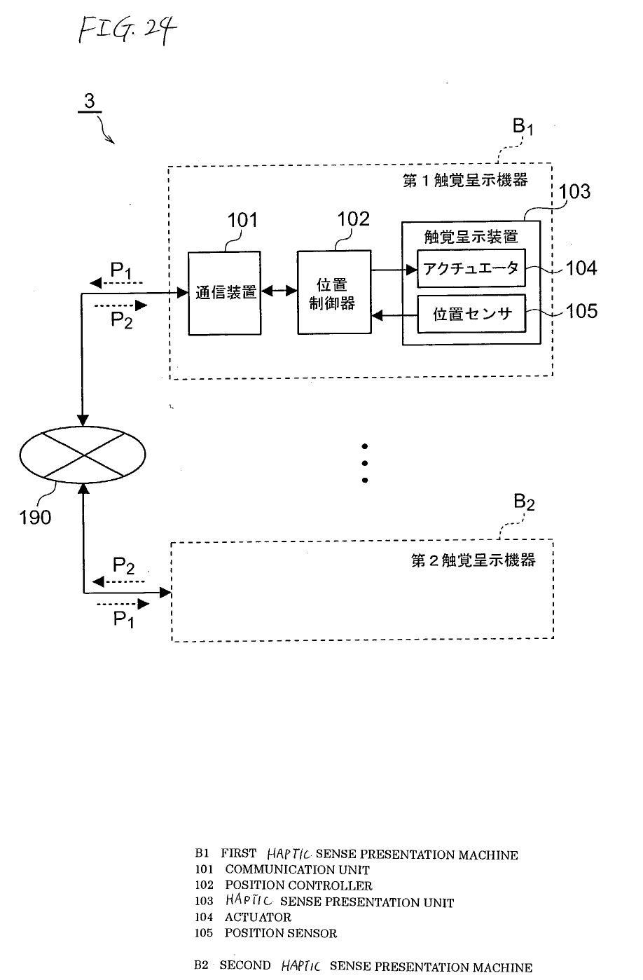

For example, an information processing system 3 shown in FIG. 24 is an example of an information processing system in a related art. This information processing system 3 is made up of a first haptic sense presentation machine B1 and a second haptic sense presentation machine B2. The first haptic sense presentation machine B1 and the second haptic sense presentation machine B2 are connected through a network 190. The internal configuration of the second haptic sense presentation machine B2 is similar to that of the first haptic sense presentation machine B1.

The first haptic sense presentation machine B1 includes a communication unit 101, a position controller 102, and a haptic sense presentation unit 103. The haptic sense presentation unit 103 has an actuator 104 for presenting a haptic sense and a position sensor 105 for detecting the state of a haptic sense.

When an operator inputs a position to a moving part, etc., of the haptic sense presentation unit 103, the position sensor 105 generates first displacement information P1 and sends the displacement information P1 to the position controller 102. The first displacement information P1 is sent through the communication unit 101 and the network 190 to the second haptic sense presentation machine B2. Likewise, second displacement information P2 is also sent from the second haptic sense presentation machine B2 to the first haptic sense presentation machine B1. The position controller 102 receives the second displacement information P2 through the communication unit 101, and controls the actuator 104 based on the second displacement information P2. Thus, the haptic sense presentation unit 103 presents a haptic sense to the operator.

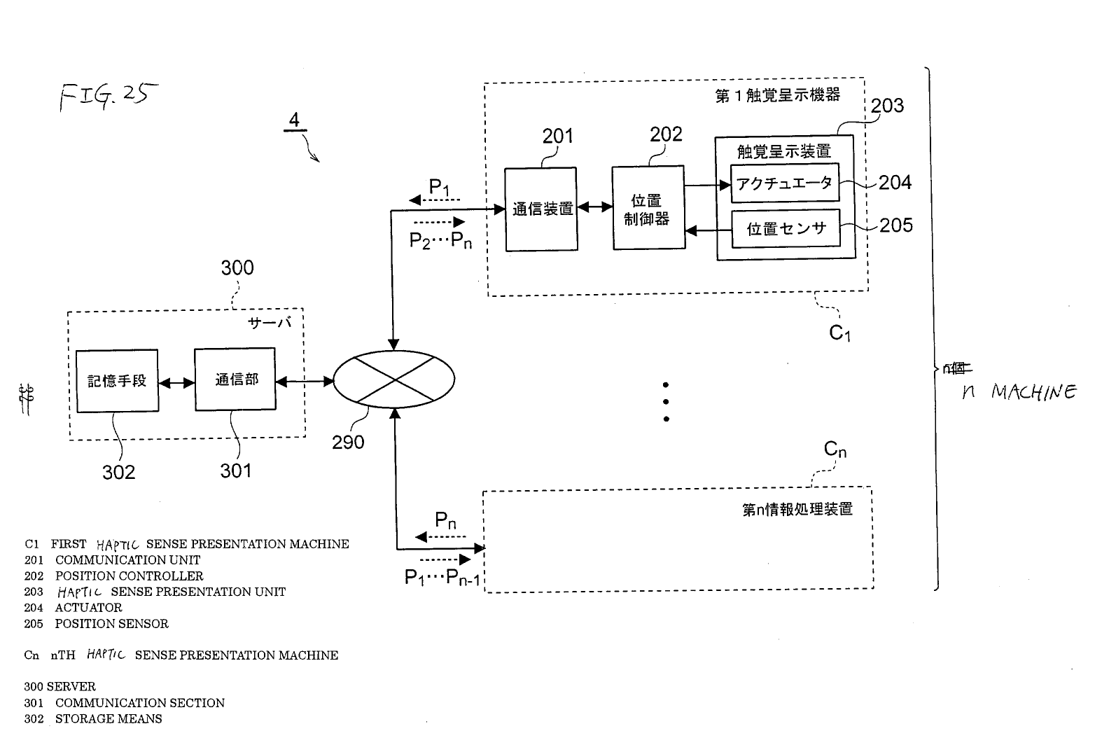

As another example, an information processing system 4 shown in FIG. 25 is available. This information processing system 4 is made up of a first haptic sense presentation machine C1 to an Nth haptic sense presentation machine Cn and a server 300. They are connected through a network 290. The internal configuration of each of the second haptic sense presentation machine C2 to the Nth haptic sense presentation machine Cn is similar to that of the first haptic sense presentation machine C1.

The first haptic sense presentation machine C1 includes a communication unit 201, a position controller 202, and a haptic sense presentation unit 103. The haptic sense presentation unit 203 has an actuator 204 for presenting a haptic sense and a position sensor 205 for detecting the state of a haptic sense.

When an operator inputs a position to a moving part, etc., of the haptic sense presentation unit 203, the position sensor 205 generates first displacement information P1 and sends the displacement information P1 to the position controller 202. The first displacement information P1 is sent through the communication unit 201 and the network 290 to the server 300. Likewise, second displacement information P2 to Nth displacement information Pn are also sent from the second haptic sense presentation machine C2 to the Nth haptic sense presentation machine Cn to the server 300.

The server 300 includes a communication section 301 and storage means 302. Each displacement information piece received from each haptic sense presentation machine is sent through the communication section 301 to the storage means 302. After all the displacement information is complete, the storage means 302 sends other displacement information pieces than the Kth displacement information to the Kth haptic sense presentation machine through the communication section 301 and the network 290.

The position controller 202 of the first haptic sense presentation machine C1 receives the second displacement information P2 to the Nth displacement information Pn through the communication unit 201, and controls the actuator 204 based on the displacement information. Thus, the haptic sense presentation unit 203 presents a haptic sense to the operator.

In the two related art examples previously described with reference to FIGS. 24 and 25, the displacement information is sent from each haptic sense presentation machine to another haptic sense presentation machine and in each haptic sense presentation machine, the haptic sense presentation unit is controlled based on the displacement information. The server 300 in FIG. 14 only mediates data transfer between the haptic sense presentation machines. Thus, as the number of the haptic sense presentation machines increases, the amount of data communicated on the network increases like a quadratic function.

In contrast to the related art examples as described above, according to the information processing system and method according to the embodiment, each haptic sense presentation system need not receive data concerning the displacement information from another haptic sense presentation system, the amount of data communicated on the network can be suppressed, and the haptic sense presented by the moving part 152 of each haptic sense presentation system can be controlled stably.

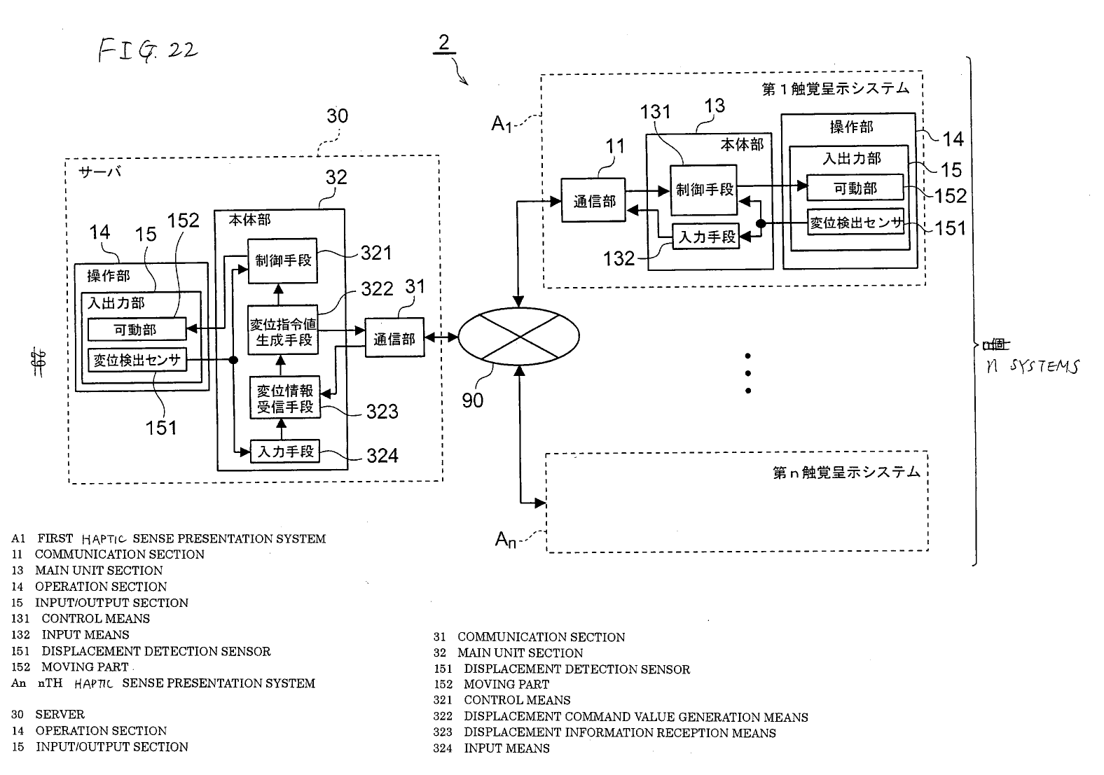

FIG. 22 is a block diagram to show the internal configuration of an information processing system 2 according to another embodiment of the invention. The embodiment is an embodiment wherein the server 20 in the previous embodiment further has an operation section 14.

The information processing system 2 is made up of a first haptic sense presentation system A1 to an Nth haptic sense presentation system An (where N is an integer of two or more) and a server 30. The first haptic sense presentation system A1 to the Nth haptic sense presentation system An and the server 30 are connected to each other through a network 90. The internal configurations of the server 30 will be discussed. The configurations of the first haptic sense presentation system A1 to the Nth haptic sense presentation system An are similar to those in the information processing system 1 of the first embodiment and therefore will not be discussed again.

The server 30 is made up of a communication section 31 of a second communication section, a main unit section 32, and the input/output section 14. The input/output section 14 is similar to the input/output section 14 of each of the haptic sense presentation systems A1 to An of the previous embodiment.

The communication section 31 receives first displacement information from the first haptic sense presentation system A1. Likewise, the communication section 31 receives second displacement information to Nth displacement information from the second haptic sense presentation system A2 to the Nth haptic sense presentation system An respectively. Then, the communication section 31 sends the displacement information to the main unit section 32.

The main unit section 32 includes a CPU, ROM, RAM, etc., and controls input/output of various pieces of information by the communication section 31 and performs computation based on the information. For this purpose, the main unit section 32 has control means 321, displacement command value generation means 322, displacement information reception means 323, and input means 324. These means are implemented as the CPU reads and executes programs stored in the ROM, etc., contained in the main unit section 32.

The input means 324 inputs server displacement information from the operation section 14. The server displacement information is displacement information concerning a moving part 152 of the operation section 14 contained in the server 30. The input means 324 send the server displacement information to the displacement information reception means 323.

The displacement information reception means 323 receives the server displacement information from the input means 324 and inputs the first displacement information to the Nth displacement information through the network 90 and the communication section 31. After all the displacement information is complete, the displacement information reception means 323 outputs the displacement information to the displacement command value generation means 322.

The displacement command value generation means 322 inputs the first displacement information to the Nth displacement information and the server displacement information from the displacement information reception means 323, and generates a first displacement command value to be sent to the first haptic sense presentation system to an Nth displacement command value to be sent to the Nth haptic sense presentation system and a server displacement command value to be sent to the control means 321 of the server 30. The server displacement command value is a value for indicating a haptic sense presented in the moving part 152 of the server 30. As a generation method of the displacement command values, the displacement command values may be found according to expressions (1) and (2) or (3) to (5) in the previou embodiment assuming that the server 30 is one haptic sense presentation system.

The displacement command value generation means 322 sends the server displacement command value thus generated to the control means 321. The displacement command value generation means 322 also sends the first displacement command value to the Nth displacement command value to the communication section 31. The communication section 31 transmits the first displacement command value to the first haptic sense presentation system A1. Likewise, the communication section 31 transmits the second displacement command value to the Nth displacement command value to the second haptic sense presentation system A2 to the Nth haptic sense presentation system An respectively.

The control means 321 inputs the server displacement command value from the displacement command value generation means 322, and controls the moving part 152 so as to present displacement responsive to the server displacement command value. That is, the control means 321 receives displacement information of the moving part 152 from a displacement detection sensor 151 for detecting displacement of the moving part 152, and performs feedback control for the moving part 152 so that the displacement information follows the displacement command value.

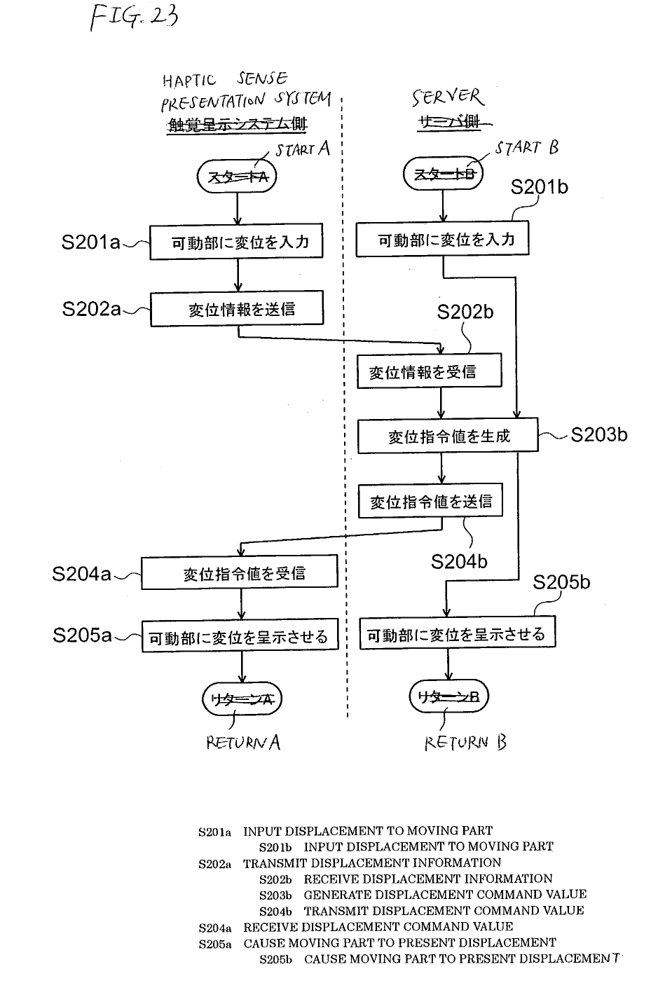

FIG. 23 is a flowchart to show the operation of the information processing system according to the embodiment. An information processing method according to the embodiment will be discussed with FIG. 23. In the information processing system, the haptic sense presentation systems operate almost in the same manner and therefore FIG. 23 shows the operation of only one haptic sense presentation system.

First, the first operator to the Nth operator operating the first haptic sense presentation system A1 to the Nth haptic sense presentation system An input each displacement to moving parts 152 of the first haptic sense presentation system A1 to the Nth haptic sense presentation system An. The first displacement information to the Nth displacement information indicating the displacements of the moving parts 152 are generated in the input/output sections 15 of the first haptic sense presentation system A1 to the Nth haptic sense presentation system An (displacement detection step of haptic sense presentation systems, S201a). The operator operating the server inputs displacement to the moving parts 152 of the server 30. The server displacement information indicating the displacement of the moving part 152 is generated in the input/output section 15 of the server 30. The server displacement information is sent to the displacement information reception means 323 (displacement detection step of server, S201b).

The first haptic sense presentation systems A1 to An transmit the first displacement information to the Nth displacement information from communication sections 11 to the server 30 (first communication step of haptic sense presentation systems, S202a). The first displacement information to the Nth displacement information transmitted are received in the communication section 31 of the server 30 (first communication step of server, S202b).

The communication section 31 of the server 30 sends the first displacement information to the Nth displacement information to the displacement information reception means 323. When the first displacement information to the Nth displacement information and the server displacement information received from the input means 324 of the server 30 are all complete, the displacement information reception means 323 sends the displacement information to the displacement command value generation means 322, which then generates the first displacement command value to the Nth displacement command value and the server displacement command value based on the first displacement information to the Nth displacement information and the server displacement information. The generation method of the displacement command values at this time is similar to that in the first embodiment (displacement command value generation step, S203b). The displacement command value generation means 322 sends the generated server displacement command value to the control means 321 of the server 30. The displacement command value generation means 322 also sends the first displacement command value to the Nth displacement command value to the communication section 31, which then transmits the first displacement command value to the Nth displacement command value to the first haptic sense presentation system A1 to the Nth haptic sense presentation system An respectively (second communication step of server, S204b).

The communication sections 11 of the first haptic sense presentation system A1 to the Nth haptic sense presentation system An receive the first displacement command value to the Nth displacement command value respectively (second communication step of haptic sense presentation systems, S204a) The communication section 11 of each haptic sense presentation system outputs the received displacement command value to the control means 131. The control means 131 sends a displacement signal to haptic sense presentation means 157 of the input/output sections 15 according to the input displacement command value. The haptic sense presentation means 157 displaces the moving part 152 for presenting a haptic sense to the operator (control step of haptic sense presentation systems, S205a). In the server 30, the control means 321 sends a displacement signal to the haptic sense presentation means 157 of the input/output sections 15 according to the server displacement command value. The haptic sense presentation means 157 displaces the moving part 152 for presenting a haptic sense to the operator (control step of server, S205b). After this, control returns to S201a and S201b and the above-described process is repeated.

The information processing system and method according to the embodiment provides the following advantages as in the previous embodiment: The amount of data communicated on the network can be suppressed, and the haptic sense presented by the moving part 152 of each haptic sense presentation system can be controlled stably.

In the embodiment, in addition to each haptic sense presentation system, the server 30 also includes the moving part 152, the displacement detection sensor 151 of a displacement detection section, and the control means 321, so that also in the server, the operator can take part in haptic sense communication.

The information processing system and method according to the invention are not limited to the embodiments, and various modifications are possible. For example, the displacement information may be not only the position data itself of the moving part 152, but also a value that can be restored as position data in the server after it is sent from each haptic sense presentation system to the server. For example, in the control period of the moving part, the change amount from displacement in the preceding period or the like maybe used as the displacement information. Likewise, the displacement command value may also be a value that can be restored in the haptic sense presentation system after it is sent from the server to each haptic sense presentation system.

The haptic sense presented in each haptic sense presentation system may be presented with a time lag as required rather than presented in an instant in response to displacement input in another haptic sense presentation system as in the embodiments described above. The magnitude of a haptic sense can be set as desired in such a manner that the moving part of another haptic sense presentation system is displaced in a magnitude twice that of displacement input in response to displacement input to the moving part of one haptic sense presentation system. To thus present the haptic sense, the control means may perform necessary calculation.

As described above in detail, the information processing system and method according to the invention provide the following advantages: The server connected to the network collectively generates the displacement command values for instructing the control means to displace the moving parts of the N haptic sense presentation systems, and sends the displacement command values to the haptic sense presentation systems. Thus, the amount of data communicated on the network can be suppressed, and the haptic sense presented by the moving part of each haptic sense presentation system can be controlled stably.

What is claimed is:

1. An information processing system comprising:
a first information processing apparatus having a first input section for accepting an input command given by a first operator, a first image display section for displaying an image for the first operator, and a first stimulus presentation section for presenting a touch stimulus to the first operator;
a second information processing apparatus which is connected to the first information processing apparatus through a network and has a second input section for accepting an input command given by a second operator, a second image display section for displaying an image for the second operator, and a second stimulus presentation section for presenting a touch stimulus to the second operator;
common image display management means for causing the first image display section and the second image display section each to display a common image;
relation giving means for relating an input command to the first input section concerning a first position in the common image displayed on the first image display section and an input command to the second input section concerning a second position in the common image displayed on the second image display section to each other; and
correlation stimulus presentation means for causing the first stimulus presentation section and the second stimulus presentation section each to present a touch stimulus responsive to the correlation between the first position and the second position in the common images when the relation giving means relates the input command to the first input section and the input command to the second input section to each other.

2. The information processing system as claimed in claim 1 wherein when the relation giving means relates the input command to the first input section and the input command to the second input section to each other, the common image display management means causes the first image display section and the second image display section each to display image information responsive to the correlation on the common image displayed on the first image display section and the second image display section.

3. The information processing system as claimed in claim 1 further comprising charging management means for charging either of the first and second operators based on previously registered information concerning charging of the operators.

4. The information processing system as claimed in claim 1 further comprising master and slave relationship giving means for setting relationship of master and slave between operation of the first operator and operation of the second operator.

5. An information processing method using an information processing system comprising:
a first information processing apparatus having a first input section for accepting an input command given by a first operator, a first image display section for displaying an image for the first operator, and a first stimulus presentation section for presenting a touch stimulus to the first operator; and
a second information processing apparatus which is connected to the first information processing apparatus through a network and has a second input section for accepting an input command given by a second operator, a second image display section for displaying an image for the second operator, and a second stimulus presentation section for presenting a touch stimulus to the second operator, the information processing method comprising the steps of:
causing the first image display section and the second image display section each to display a common image;
relating an input command to the first input section concerning a first position in the common image displayed on the first image display section and an input command to the second input section concerning a second position in the common image displayed on the second image display section to each other; and
causing the first stimulus presentation section and the second stimulus presentation section each to present a touch stimulus responsive to the correlation between the first position and the second position in the common images when the input command to the first input section and the input command to the second input section are related to each other.

6. The information processing method as claimed in claim 5 wherein when the input command to the first input section and the input command to the second input section are related to each other, the first image display section and the second image display section are caused each to display image information responsive to the correlation on the common image displayed on the first image display section and the second image display section.

7. The information processing method as claimed in claim 5 further comprising the step of charging either of the first and second operators based on previously registered information concerning charging of the operators.

8. The information processing method as claimed in claim 5 further comprising the step of setting relationship of master and slave between operation of the first operator and operation of the second operator.

9. An information processing system comprising:
N haptic sense presentation systems (where N is an integer of two or more) and a server being connected to the N haptic sense presentation systems through a network, wherein
each of the N haptic sense presentation systems comprises:
a moving part that can be displaced;
a displacement detection section for generating displacement information based on displacement input to the moving part;
control means for displacing the moving part for presenting a haptic sense according to a displacement command value; and
a first communication section for transmitting the displacement information generated by the displacement detection section to the server and receiving the displacement command value from the server and sending the displacement command value to the control means, and wherein
the server comprises:
a second communication section for receiving the displacement information from each of the N haptic sense presentation systems and transmitting the displacement command value to each of the N haptic sense presentation systems; and
displacement command value generation means for generating the displacement command value for instructing the control means of each of the N haptic sense presentation systems to displace the moving part for presenting a haptic sense based on the displacement information generated by the displacement detection section of each of the N haptic sense presentation systems and sent from the first communication section through the network to the second communication section.

10. The information processing system as claimed in claim 9 wherein the server further comprises:
a moving part that can be displaced;
a displacement detection section for generating displacement information based on displacement input to the moving part; and
control means for displacing the moving part for presenting a haptic sense according to a displacement command value; and wherein
the displacement command value generation means generates the displacement command value for instructing the control means of each of the server and the N haptic sense presentation systems to displace the moving part for presenting a haptic sense based on the displacement information generated by the displacement detection section of the server and the displacement information generated by the displacement detection section of each of the N haptic sense presentation systems and sent from the first communication section through the network to the second communication section.

11. An information processing method using N haptic sense presentation systems (where N is an integer of two or more) each comprising a moving part that can be displaced and a server being connected to the N haptic sense presentation systems through a network, the information processing method comprising:
a displacement detection step of generating displacement information based on displacement input to the moving part of each of the N haptic sense presentation systems;
a first communication step of transmitting the displacement information generated in the displacement detection step from each of the N haptic sense presentation systems to the server;
a displacement command value generation step of generating in the server a displacement command value for instructing the moving part of each of the N haptic sense presentation systems to be displaced for presenting a haptic sense based on the displacement information generated in the displacement detection step and sent from the first communication step;
a second communication step of transmitting the displacement command value generated in the displacement command value generation step from the server to each of the N haptic sense presentation systems; and
a control step of displacing the moving part of each of the N haptic sense presentation systems for presenting a haptic sense according to the displacement command value sent from the second communication step to each of the N haptic sense presentation systems.

12. The information processing method as claimed in claim 11 wherein the server comprises a moving part that can be displaced, wherein
the displacement detection step is to further generate displacement information based on displacement input to the moving part of the server, wherein
the displacement command value generation step is to generate in the server the displacement command value for instructing the moving part of each of the server and the N haptic sense presentation systems to be displaced for presenting a haptic sense based on the displacement information generated in the displacement detection step based on displacement input to the moving part of each of the server and the N haptic sense presentation systems, and wherein
the control step is to displace the moving part of each of the server and the N haptic sense presentation systems for presenting a haptic sense according to the displacement command value generated in the displacement command value generation step.
